(19) United States
(12) Patent Application Publication
(10) Pub. No.: US 2025/0138894 A1
(43) Pub. Date: May 1, 2025

(54) Information Technology Infrastructure Resource Grouping

(71) Applicant: Cloudflare, Inc., San Francisco, CA (US)

(72) Inventors: Ryan Standt, Emeryville, CA (US); Stephen Welham, Woodinville, WA (US); Meigy Tsai, Sunnyvale, CA (US); David Naylor, Berkeley, CA (US); Eric Carino, Milpitas, CA (US)

(73) Assignee: Cloudflare, Inc., San Francisco, CA (US)

(21) Appl. No.: 18/930,000

(22) Filed: Oct. 29, 2024

Related U.S. Application Data
(60) Provisional application No. 63/594,263, filed on Oct. 30, 2023.

(51) Int. Cl. G06F 9/50

(52) U.S. Cl. CPC G06F 9/5027; G06F 9/5072

(57) ABSTRACT

A method involves receiving data identifying a set of information technology (IT) resources of an IT infrastructure and generating a first IT resource dependency graph using the set of IT resources. First INCLUDES and EXCLUDES configuration data indicating one or more IT resources that should either be included or excluded from an IT resource group is received. Initial selection statuses for IT resources in the first dependency graph are set based on the first INCLUDES and EXCLUDES configuration data. A breadth-first search of the first dependency graph is performed to generate the IT resource group based on the initial selection status for the IT resources in the first dependency graph, and the IT infrastructure is updated or managed using the IT resource group.

### RELATED APPLICATIONS

This application claims priority to U.S. Provisional Patent Application No. 63/594,263, filed Oct. 30, 2023, all of which is incorporated herein by reference for all purposes.

### BACKGROUND

Cloud computing involves a variety of technologies and methods to virtualize physical computer resources and applications. One aspect of cloud computing is Infrastructure-as-a-Service (IaaS), which leverages geographically distributed compute nodes, such as servers, for information technology (IT) infrastructure implementation. This infrastructure, including computer networks, utilizes virtual hardware resources like virtualized networks, virtual machines, and virtualized storage.

Cloud service providers offer means for establishing virtualized network connectivity among physical or virtualized compute resources which may span multiple regions within one provider, may span multiple providers, and may also span multiple “on-premise” sites (such as private offices or data centers). Such cloud service providers include AMAZON WEB SERVICES, GOOGLE CLOUD PLATFORM, and MICROSOFT AZURE.

The basic unit of networking in cloud computing is a group of compute instances connected by a logically isolated local network—the cloud equivalent of a traditional on-premise local area network. Some cloud service providers refer to such groups of compute instances as virtual private clouds (VPCs), while other cloud service providers refer to such groups of compute instances as virtual networks (VNets). VPCs and VNets are generically referred to herein as networks. Additionally, some cloud IT resources act as containers for other cloud resources. An IT resource group may contain multiple IT resources which are provisioned and managed together. It is usually the case that IT resources within the IT infrastructure have relationships with one another, and one important relationship is resource dependency. For example, in most public clouds, a subnet can only exist in a virtual network, so the subnet is said to depend on the virtual network.

### SUMMARY

In some aspects, the techniques described herein relate to a method, including: receiving, by one or more processors, data identifying a set of information technology (IT) resources of an IT infrastructure; generating, by the one or more processors, a first IT resource dependency graph using the set of IT resources; receiving, by the one or more processors, first INCLUDES and EXCLUDES configuration data indicating one or more IT resources that should either be included or excluded from an IT resource group; identifying and setting, by the one or more processors, an initial selection status for IT resources in the first dependency graph based on the first INCLUDES and EXCLUDES configuration data; performing, by the one or more processors, a breadth-first search of the first dependency graph to generate the IT resource group based on the initial selection status for the IT resources in the first dependency graph; and updating or managing, by the one or more processors, the IT infrastructure using the IT resource group.

In some aspects, the techniques described herein relate to a non-transitory computer-readable medium storing instructions for executing a computer-implemented method, the computer-implemented method including: receiving, by one or more processors, data identifying a set of information technology (IT) resources of an IT infrastructure; generating, by the one or more processors, a first IT resource dependency graph using the set of IT resources; receiving, by the one or more processors, first INCLUDES and EXCLUDES configuration data indicating one or more IT resources that should either be included or excluded from an IT resource group; identifying and setting, by the one or more processors, an initial selection status for IT resources in the first dependency graph based on the first INCLUDES and EXCLUDES configuration data; performing, by the one or more processors, a breadth-first search of the first dependency graph to generate the IT resource group based on the initial selection status for the IT resources in the first dependency graph; and updating or managing, by the one or more processors, the IT infrastructure using the IT resource group.

### BRIEF DESCRIPTION OF THE DRAWINGS

FIG. 1 shows a simplified example of a distributed cloud network, in accordance with some embodiments.

FIG. 2 provides a simplified diagram of an example IT resource group (ITR) controller used for managing IT infrastructure such as the network introduced in FIG. 1, in accordance with some embodiments.

FIG. 3A illustrates a directed graph of IT resources and the dependencies therebetween, in accordance with some embodiments.

FIGS. 3B-3D illustrate example scenarios for generating IT resource groups using the dependency graph of FIG. 3A, in accordance with some embodiments.

FIG. 4 illustrates a high-level example process for generating and using IT resource groups, in accordance with some embodiments.

FIGS. 5-15 illustrate details of the high-level example process for generating and using IT resource groups introduced in FIG. 4, in accordance with some embodiments.

FIG. 16 illustrates an example compute node, in accordance with some embodiments.

### DETAILED DESCRIPTION

Infrastructure as Code (IaC) is a popular paradigm for managing (e.g., provisioning, configuring, and destroying) programmable information technology (IT) infrastructure (e.g., public cloud services or on-premises systems with configuration APIs). IaC tools often represent IT infrastructure as a collection of discrete IT resources, each of which might represent a physical resource (e.g., a server), a virtual resource (e.g., a virtual machine (VM)), or a piece of configuration (e.g., a secret key or an association between other IT resources).

IT resources within the IT infrastructure have relationships with one another, and one important relationship is IT resource dependency. That is, some IT resources depend on other IT resources in order to be created or configured. For example, in many public clouds, a subnet can only exist in a virtual network, so in this example, the subnet depends on the virtual network.

In some scenarios, a user of an IaC tool may need to group related IT resources together—for example, to offer a good user experience to a user selecting a subset of their IT resources to work with (e.g., picking a group of existing resources to monitor or clone). However, a typical IT infrastructure deployment might comprise thousands of IT resources, so selecting IT resources manually is tedious and error prone.

Some conventional solutions automatically group IT infrastructure resources (“ITRs”) by including the totality of the IT resources in a dependency graph. Unfortunately, this method can result in adding more IT resources than the user intends. Other conventional solutions may use query expressions such as add “all resources of type ‘vpc’” or add “all resources with tag ‘prod’”. However, this approach requires significant manual effort to tag individual IT resources and/or fails to capture dependencies needed to deploy the IT resources.

Processes are disclosed herein for advantageously selecting “useful” groupings of IT infrastructure resources automatically, for example by an IaC tool, to improve a user experience thereof and to reduce user errors. The IT resource grouping may thereafter be used as an input to, or an output from, additional processes for managing and updating IT infrastructure.

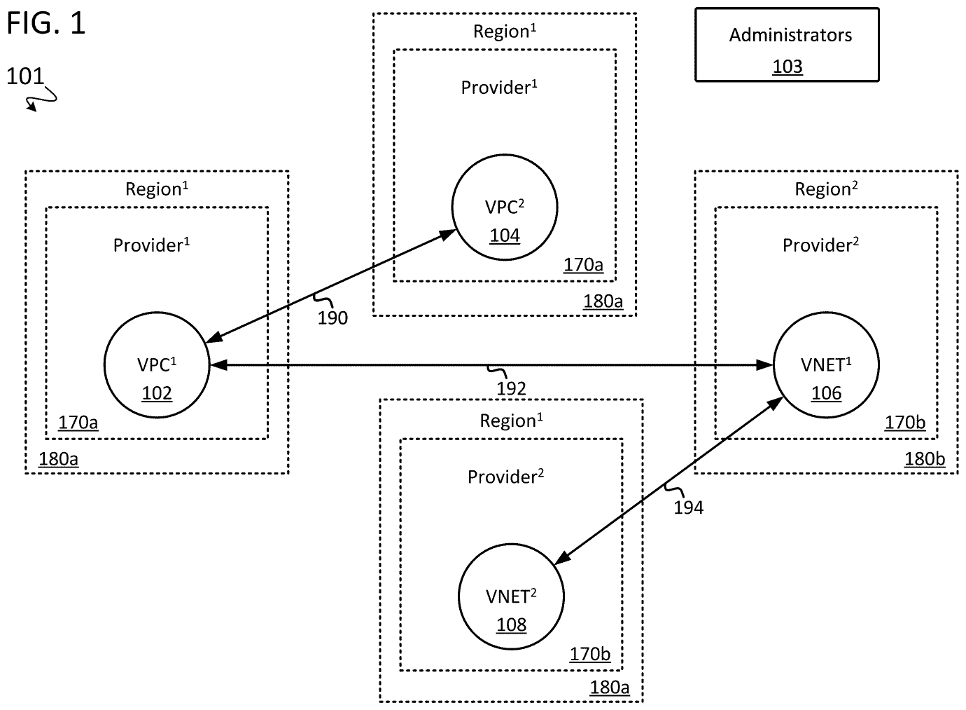

For context, FIG. 1 shows a simplified example of a distributed cloud network (“network”) 101 that is implemented within an IT infrastructure, in accordance with some embodiments. In the example shown, an organization has established a multi-cloud strategy using the network 101 by engaging with various cloud service providers 170a-b to architect and manage a distributed cloud network infrastructure. The simplified example network 101 includes a first logically isolated local network VPC¹ (“network”) 102, a second logically isolated local network VPC² (“network”) 104, a third logically isolated local network VNET¹ (“network”) 106, a fourth logically isolated local network VNET² (“network”) 108, and network connections (representing routing reachability) 190, 192, and 194. The network 102 and the network 104 are both operated using a first cloud-networking Provider¹ 170a within a first geographic Region¹ 180a, the network 106 is operated using a second cloud-networking Provider² 170b within a second geographic Region² 180b, and the network 108 is operated using the second Provider² 170b within the first geographic Region¹ 180a.

One or more administrators 103 associated with the organization that deployed or are simply managing the network 101 may be responsible for planning, provisioning, and maintaining that network. However, as mentioned above, tailored knowledge of IT resources within the network 101 and dependencies therebetween are difficult to assemble and be made use of using conventional solutions. As an example of such dependencies, the peering connections 190 and 194, and the VPN connection 192 shown in FIG. 1 are themselves representative of IT resources and are therefore dependent on the VPCs that they connect.

Disclosed herein is an IT resource group (ITR) controller which advantageously enables the administrators 103 to manage IT infrastructure, including on-premise, self-hosted resources, cloud networks distributed across multiple providers and multiple regions, data centers, virtualization environments, software and management tools, security infrastructure, communication systems, and so on. The ITR controller may be implemented by one or more processors at one or more compute nodes. The ITR controller has the means to access an organization's public cloud network accounts (e.g., by holding credentials for those accounts) to access each of an organization's public cloud network accounts to build and manage sets of IT resources, designated herein as “IT resource groups”, in an ITR database. Thereafter, a user, such as one or more of the administrators 103, may use the IT resource groups to holistically view, modify, remove, and create IT resources, configurations, connections, linkages, and groupings, among other parameters, for managing IT infrastructure such as a distributed cloud network.

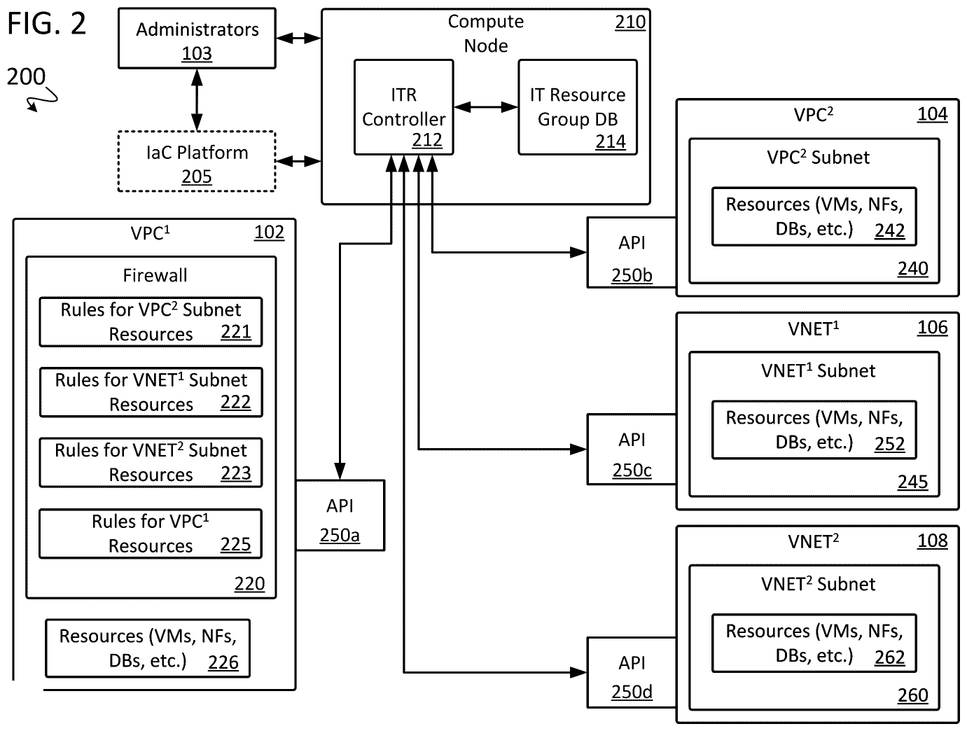

FIG. 2 provides a simplified diagram of a system 200 that includes an example ITR controller 212 at one or more compute nodes 210, an example IT resource group database (DB) 214 at the one or more compute nodes 210, and the network 101 introduced in FIG. 1, in accordance with some embodiments. FIG. 2 additionally includes the networks 102, 104, 106, 108, and the administrators 103 introduced in FIG. 1. Also shown is an optional Infrastructure as Code (IaC) IT infrastructure management application (“IaC Platform”) 205 communicatively coupled to the administrators 103, the ITR controller 212, and the IT resource group database 214. In some of the embodiments disclosed herein, a particular process or process step may be described as being performed by the ITR controller 212 for brevity. However, it is understood that each of the processes and process steps disclosed herein may be performed by, or be performed using the ITR controller 212, the IaC platform 205, and/or one or more other processors at other compute nodes.

The ITR controller 212 and the IT resource group database 214 are operable to be used by the administrators 103 to manage IT infrastructure, such as the network 101. The IT resources 226, 242, 252, and 262 may include computing resources such as virtual machines, and containers, storage resources such as file storage, block storage, object storage, and database resources, networking resources such as virtual network gateways, firewalls, load balancers, and virtual private networks, and application services such as web apps, and content delivery networks, among other IT resources.

As an example, the VPC¹ network 102 includes an IT resource firewall 220, and other VPC¹ IT resources 226. Similarly, the VPC² network 104 includes a VPC² subnet 240 having IT resources 242, the VNET¹ network 106 includes a VNET¹ subnet 245 having IT resources 252, and the VNET² network 108 includes a VNET² subnet 260 having IT resources 262. As an example of the relationship between IT resources as described herein, since the firewall 220 is instantiated within the VPC¹ network 102, the firewall 220 depends on the VPC¹ network 102, and is referred to herein as a descendant thereof. As a corollary, the VPC¹ network 102 is referred to herein as an ancestor of the firewall 220.

The firewall 220 provisioned at the network 102 is configured to manage network traffic associated with the cross-cloud networks 104, 106, and 108. As such, the firewall 220 includes firewall rules 221 for traffic associated with the IT resources 242 of the VPC² subnet 240, firewall rules 222 for traffic associated with the IT resources 252 of the VNET¹ subnet 245, firewall rules 223 for traffic associated with the IT resources 262 of the VNET² subnet 260, and local firewall rules 225 for traffic associated with the IT resources 226 of the VPC¹ network 102.

The providers 170a-b for the networks 102, 104, 106, and 108 expose at least one Application Programming Interface (API), respectively 250a-d, that is optionally managed by an API Gateway or API Management service thereof (not shown). The APIs 250a-d are conventionally accessible via endpoints or an IaC interface and enable a wide range of operations, including querying for provisioned IT resources and their configurations.

The ITR controller 212 is operable to communicate with each of the APIs 250a-d, as well as with the IT resource group database 214. The ITR controller 212 may implement an IaC IT infrastructure management application for managing the network 101 or may communicate with and/or receive commands from the IaC IT infrastructure management application 205 to assist in managing the network 101.

The IT resource group database 214 and associated ITR controller 212 advantageously enable the administrators 103 to manage complex cloud networks distributed across multiple providers and multiple regions. In some embodiments, the ITR controller 212 possesses credentials to access each of an organization's public cloud network accounts to identify and store IT resources of the network 101 and dependencies therebetween.

In some embodiments, the ITR controller 212 provides a portal (e.g., a user interface), which enables a user such as the administrators 103 to view all IT resources in one application environment. The portal may support convenient features like sorting, searching, and filtering. When coupled with a cloud management tool (i.e., a tool that can monitor and modify cloud resources, such as the IaC IT infrastructure management application 205), the ITR database 214 enables the display and management of IT resources and their respective dependencies and groupings within and across cloud networks.

### Network Resource Grouping

As mentioned above, the ITR controller 212 may be accessed and controlled by the administrators 103 or by another cloud networking management tool, such as the IaC IT infrastructure management application 205, using a query language to manually and/or automatically define dynamic (i.e., sometimes changing) groups of IT resources within the ITR database 214 on-the-fly.

The terminology related to IT resource sets used herein includes a “coherent set of IT resources”, a “descendant IT resource”, and an “ancestor IT resource”. A coherent set of IT resources is defined herein as a set of IT resources that can be deployed within an IT infrastructure successfully by an IaC tool. Having a coherent set means that the IT resources of that set do not include dangling references. As such, if a first IT resource refers to a second IT resource by reference, the second IT resource must also be in the set. Additionally, the first IT resource and the second IT resource should exist in the same IaC specification (i.e., they are both managed by the same IaC tool). As such, the second IT resource may already exist, in which case the IaC tool will update it based on the IaC specification if a prescribed configuration for the second IT resource in the IaC specification is different than the actual configuration of the second IT resource. If the second IT resource does not yet exist, the IaC tool will create the second IT resource based on the IaC specification.

As described herein, if a first IT resource identifies a second IT resource “by reference”, this means that both IT resources are under the management of the same IaC tool and so both must have respective configurations defined in the same IaC specification. In contrast, if a first IT resource identifies a second IT resource “by ID”, this means that the second IT resource is considered to be out of scope for the IaC tool and/or the IaC specification and therefore is expected to already exist. Indication of IT resources by ID advantageously makes it possible for an IaC tool to create and/or manage IT resources (in the IaC specification) that depend on IT resources that are not managed by the same IaC tool (i.e., they are not in the same IaC specification).

A descendant IT resource is defined herein as an IT resource that depends on another IT resource (including indirectly, i.e., if A depends on B, and B depends on C, then A is a descendant of C). An ancestor IT resource is defined herein as an IT resource depended on by another IT resource (including indirectly, i.e., if A depends on B, and B depends on C, then C is an ancestor of A).

Two criteria for processes that automatically group IT resources in an IT resource group as disclosed herein include keeping coherent sets of IT resources together, and the automatic inclusion/exclusion of IT resources based on a given set of configuration data. Regarding the criteria for keeping coherent sets together, IT resource grouping processes disclosed herein always produce a coherent set such that the set can be deployed without errors due to missing IT resources. Regarding the criteria of automatic inclusions/exclusions, when a user adds an IT resource to an IT resource group, the resource grouping process disclosed herein automatically adds the IT resource's ancestors (to maintain a coherent set) and the IT resource's descendants (as a convenience to the user since the user probably wants the descendants, and this saves the effort of manually selecting all descendants). Similarly, when a user removes an IT resource from an IT resource group, the IT resource's descendants are automatically removed by the resource grouping process (to maintain a coherent set) along with any ancestors for whose inclusion the removed IT resource was solely responsible (as a convenience to the user). Each of these criteria improves the user experience by (1) reducing the chance of deployment errors, and (2) reducing the manual work required of the user.

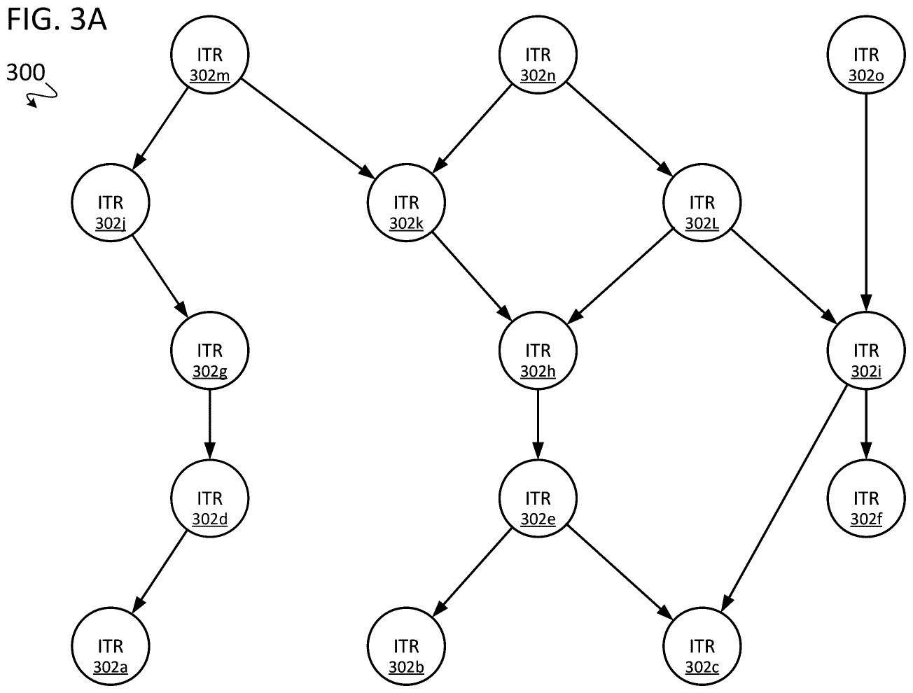

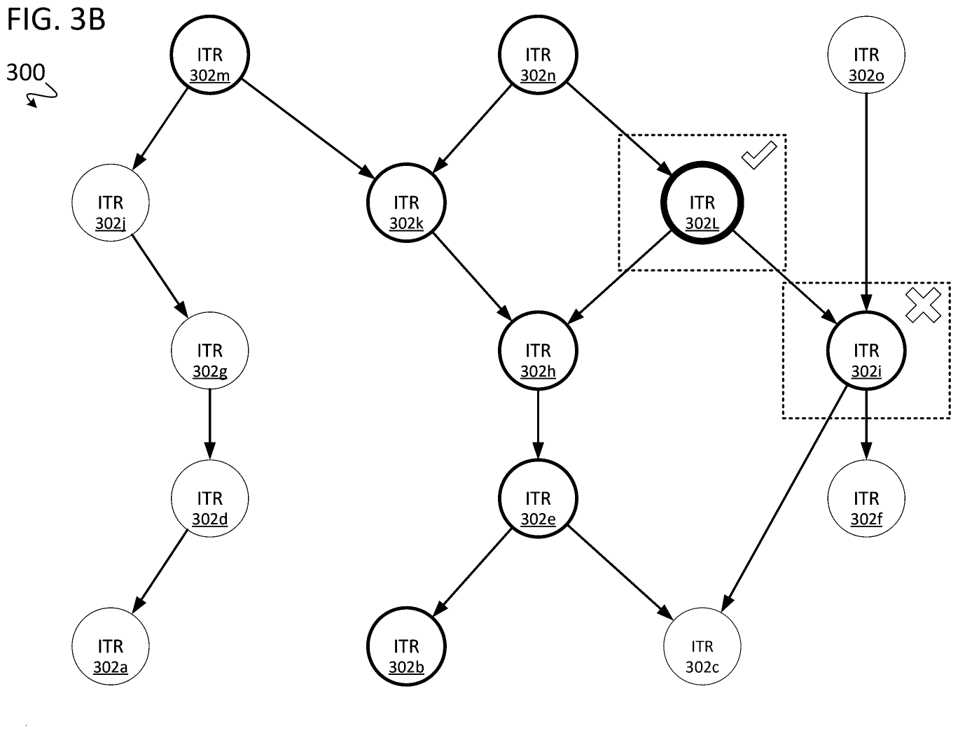

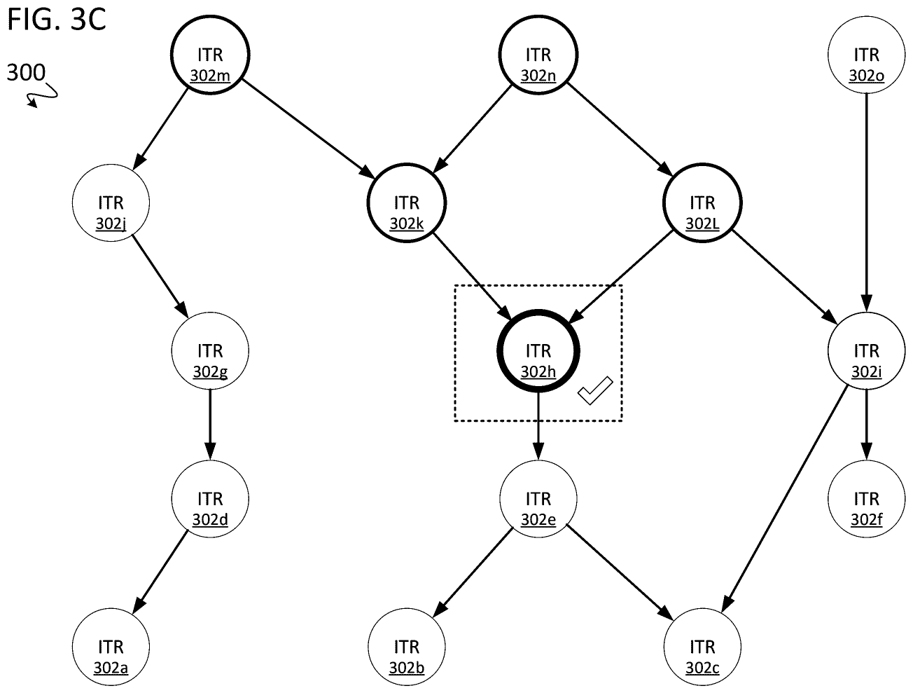

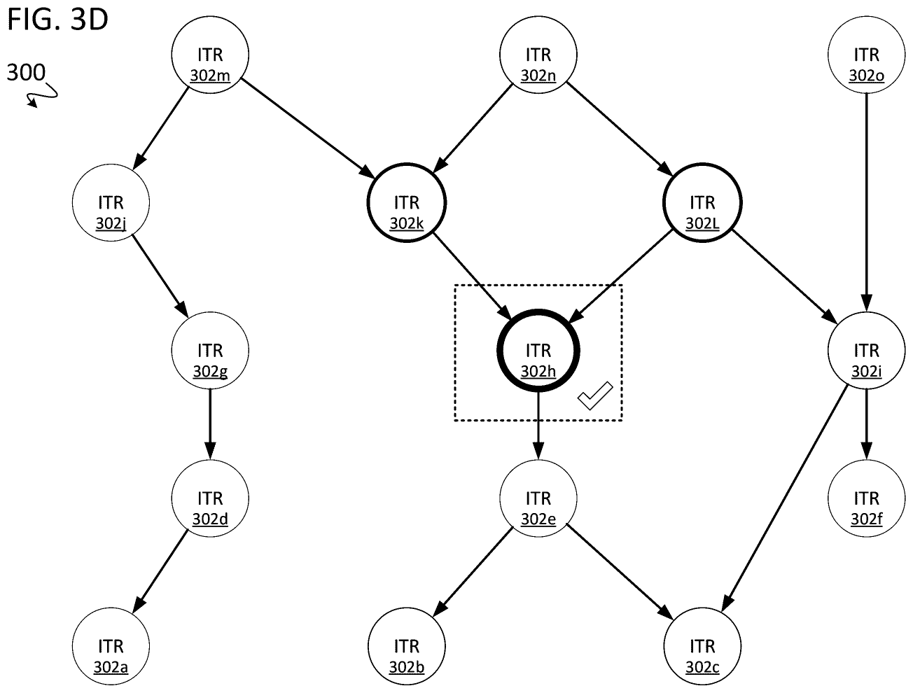

As a high-level example, a directed IT resource dependency graph is illustrated in FIGS. 3A-D, in accordance with some embodiments. In the context of Infrastructure as Code (IaC), a directed graph ensures that IT resources are provisioned in the correct order based on their dependencies. In general, first nodes that precede a given node are ancestors of that node. Similarly, second nodes that follow the given node are descendants of that node.

The dependency graph 300 shown in FIG. 3A includes nodes 302a-o which represent IT resources (“ITR”), and edges (arrows) which represent dependencies between the IT resources 302a-o. For example, the IT resource 302e depends on an ancestor IT resource 302h. As such, the directed edge from the IT resource 302h to 302e graphically illustrates that the IT resource 302h must be created and fully provisioned before the IT resource 302e can be instantiated. This type of dependency ensures that any configurations or data provided by the IT resource 302h are available to the IT resource 302e when it is initialized. To avoid issues such as circular dependencies or dangling references, the dependency graph must be acyclic and well-formed, ensuring that each IT resource is provisioned only after all its dependencies are satisfied.

A first scenario illustrating automatically grouping IT resources is shown in FIG. 3B, in accordance with some embodiments. In the scenario shown, a user or another process has identified the IT resource 302L as an IT resource to be explicitly added to an IT resource group and has identified the IT resource 302i as an IT resource to be explicitly excluded from the IT resource group. Upon inclusion of the IT resource 302L, any direct or indirect ancestors (i.e., 302n) of that IT resource that are not explicitly excluded are automatically added to the IT resource group. Additionally, descendants of the IT resource 302L (i.e., 302h, 302e, and 302b)—aside from explicitly excluded resources and their descendants (i.e., 302i, 302c, and 302f) are added to the IT resource group. Ancestors of the detected descendants are also added to the IT resource group (i.e., 302k and 302m).

As disclosed herein, adding ancestors to the IT resource group may be performed in several different ways, depending on the desired outcome. In some scenarios, each ancestor IT resource is added to the IT resource group as part of a managed configuration. In such embodiments, the IT resources are added to the IT resource group as part of a read-write configuration to be managed by the IaC specification. This methodology involves recursively adding the IT resource's ancestors, and then those IT resource's ancestors, and so on, because making changes to an IT resource requires that the IT resource have no dangling references (a reference to an IT resource that is not also part of the IaC specification, or an identification by ID to an IT resource that no longer exists or has not yet been created). For example, in a second scenario shown in FIG. 3C, the IT resource 302h is added to the IT resource group, and therefore each of the ancestors of the IT resource 302h (i.e., 302k, 302m, 302n, and 302L) are also added to the IT resource group as managed resources.

In some embodiments, each ancestor IT resource is added to the IT resource group as a read-only reference so that any descendant IT resource thereof does not have a dangling reference. As such, the IT resource will not be modified/managed by the IaC tool—it's simply there to give the IaC tool the information it needs to manage any descendant IT resource. In some embodiments, it is acceptable for a referenced IT resource to have dangling references to its own ancestors since the IaC tool will not attempt to modify read-only resources.

For example, in a third scenario shown in FIG. 3D, the IT resource 302h is added to the IT resource group as an IT resource with non-managed/read-only ancestors, and therefore only the direct ancestors of that IT reference (i.e., 302k, and 302L) need to be added to the IT resource group (as non-managed/read-only IT resources). Since the direct ancestors of the IT resource 302h are added as a non-managed IT resources, it is acceptable that indirect ancestor IT resources 302m and 302n of the selected IT resource 302h are not added to the resource group.

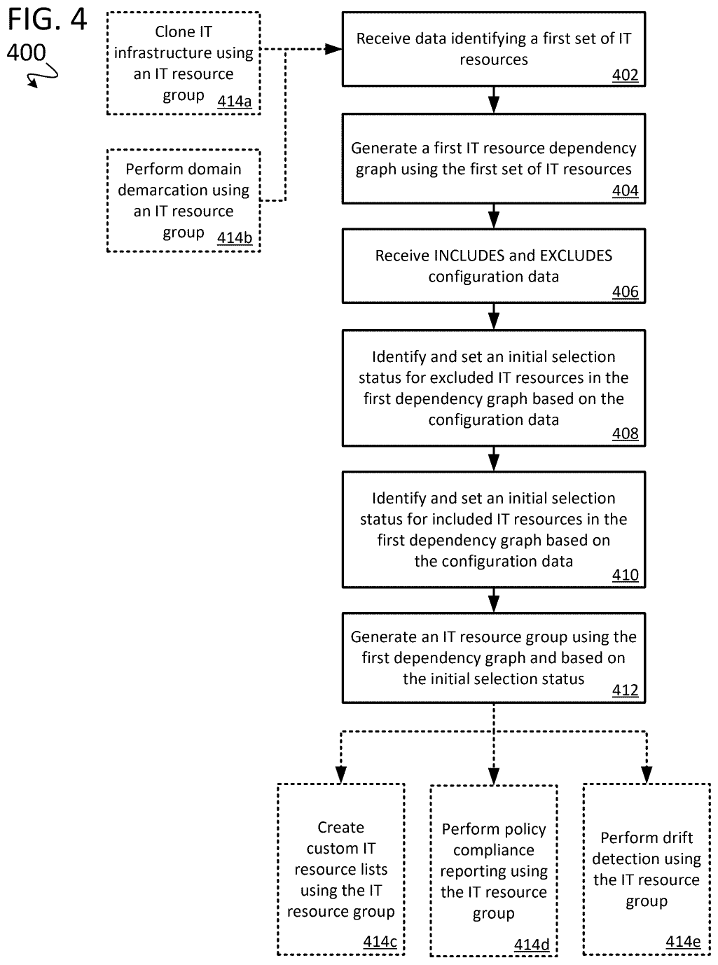

FIG. 4 illustrates a high-level example process 400 for generating and using IT resource groups, in accordance with some embodiments. The particular steps, order of steps, and combination of steps are shown for illustrative and explanatory purposes only. Other embodiments can implement different particular steps, orders of steps, and combinations of steps to achieve similar functions or results.

In some of the embodiments disclosed herein, steps of the process 400 are described as being performed by the ITR controller 212 for brevity. However, it is understood that each of the processes and process steps disclosed herein may be performed by, or be performed using, the ITR controller 212, the IaC platform 205, and/or one or more processors at a compute node.

At step 402 (with reference to FIG. 2), the ITR controller 212 receives (e.g., from the administrators 103 or the IaC IT infrastructure management application 205) data identifying a set of IT resources that are associated with, or will be associated with, an IT infrastructure (e.g., of one or more networks). The data identifying an IT resource may include, but is not limited to, IT resource IDs, associated current and past configuration data, associated current and past state data, associated parameters, associated meta-data, associated IaC data objects, and so on.

At step 404, the ITR controller 212 generates a first IT resource dependency graph (e.g., similar to that shown in FIG. 3A) using the set of IT resources. In some embodiments, the first IT resource dependency graph may be generated using techniques described in commonly assigned U.S. patent application Ser. No. 18/597,234, filed Mar. 6, 2024, all of which is incorporated herein by reference in its entirety. The first IT resource dependency graph may thereafter be stored by the ITR controller 212 in the IT resource group database 214 as, or as part of, a data object.

At step 406, the ITR controller 212 receives INCLUDES and EXCLUDES configuration data from a user or as part of another process. The configuration data includes data objects referred to herein as INCLUDES, INCLUDES WITH REFERENCED ANCESTORS, and EXCLUDES.

The INCLUDES data object identifies IT resources that the user has selected to be explicitly included in the IT resource group that is generated by the process 400. The INCLUDES WITH REFERENCED ANCESTORS data object identifies IT resources that the user has chosen to be explicitly included in the generated IT resource group with referenced ancestors. The EXCLUDES data object identifies IT resources that the user has chosen to be explicitly excluded from the generated IT resource group.

As part of the process 400, the ITR controller 212 sets a selection status for one or more IT resources (e.g., in temporary data, in metadata thereof, and/or within the IT resource group database 214 in association with a respective IT resource). The selection status values include UNSET, EXPLICITLY EXCLUDED, IMPLICITLY EXCLUDED, EXPLICITLY INCLUDED, IMPLICITLY INCLUDED, and IMPLICITLY INCLUDED AS REFERENCE. In most scenarios, the selection status of each of the IT resources in the set of IT resources is initially configured as UNSET. However, in some scenarios described below, the process 400 may be performed multiple times or may be performed after an initial process is performed, and as such it may be the case that the selection status of one or more IT resources of the set of IT resources may be set to a value other than UNSET.

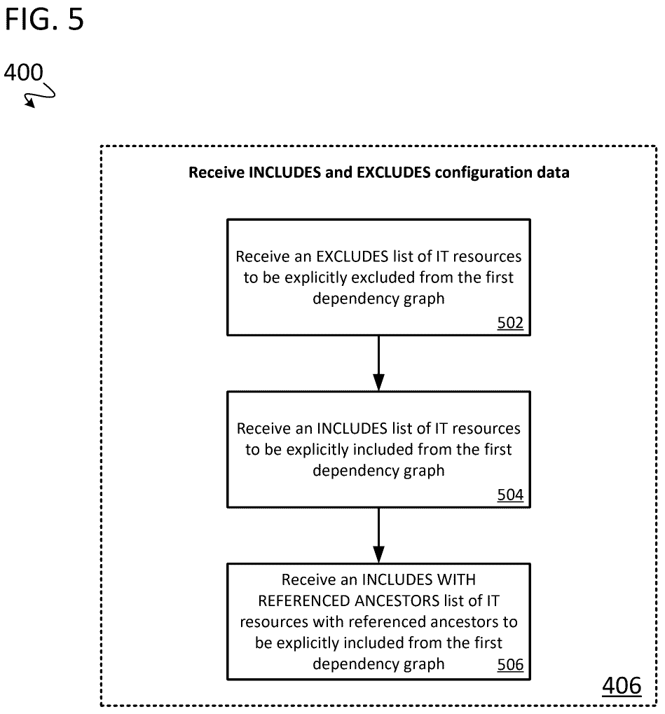

In some embodiments, the ITR controller 212 may provide a graphical user interface that displays IT resources and allows a user to configure the selection status for each of the displayed IT resources to generate the INCLUDES and EXCLUDES configuration data. The user interface may additionally include search and filtering operations to aid the user in selecting particular IT resources. In other embodiments, the ITR controller 212 may generate the INCLUDES and EXCLUDES configuration data based on query language commands received from a user or from another process. Details of step 406 are described below with reference to FIG. 5.

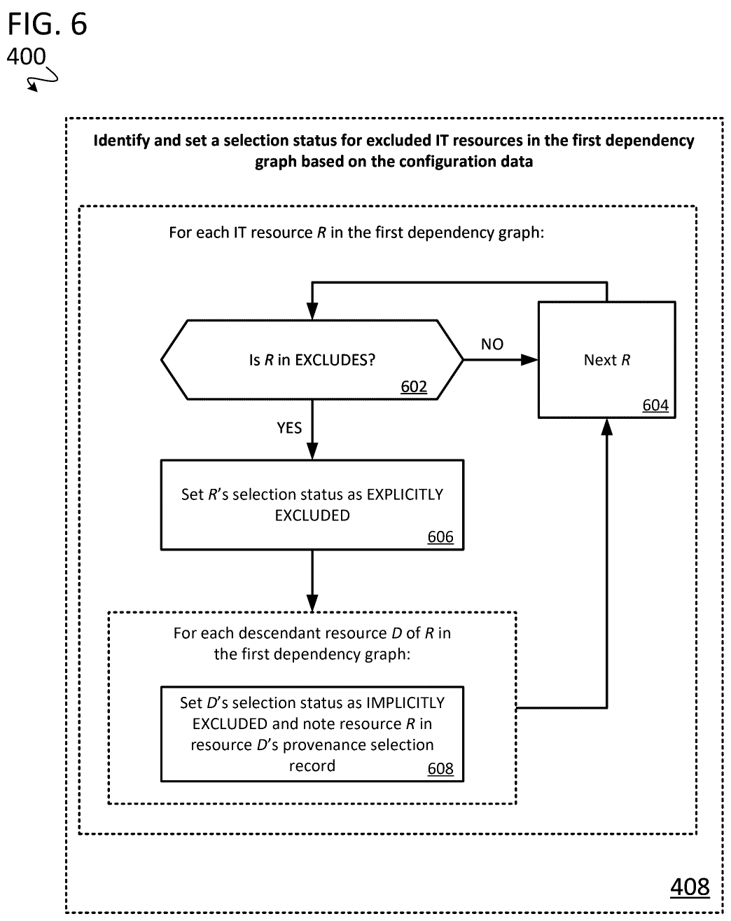

At step 408, the ITR controller 212 identifies and sets an initial selection status for each excluded IT resource within the first dependency graph based on the received INCLUDES and EXCLUDES configuration data. Details of step 408 are described below with reference to FIG. 6.

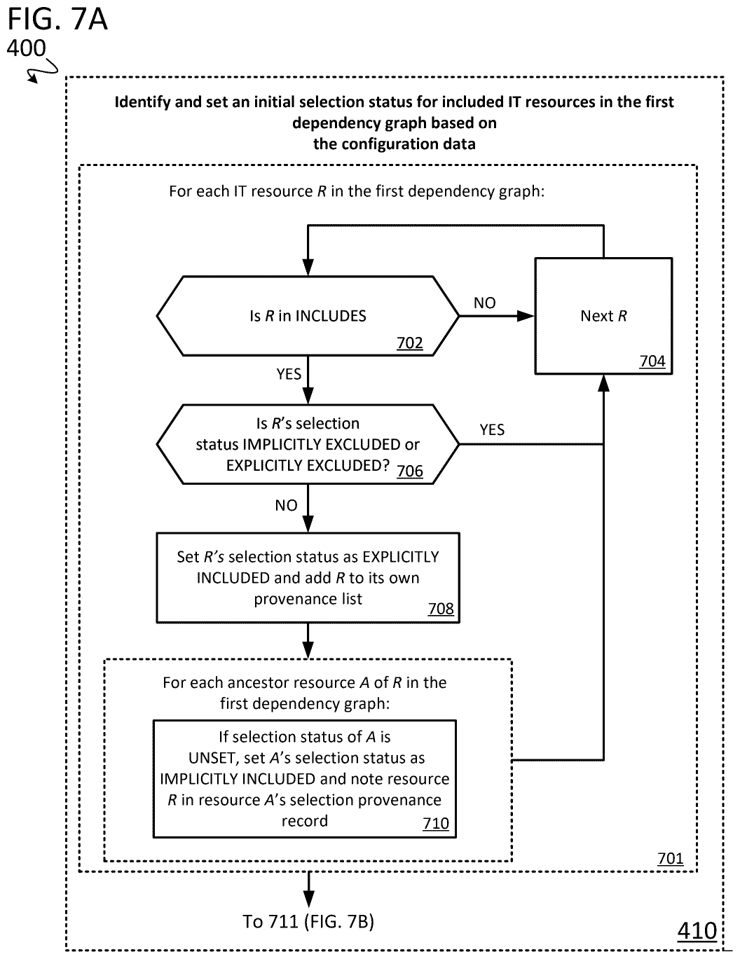

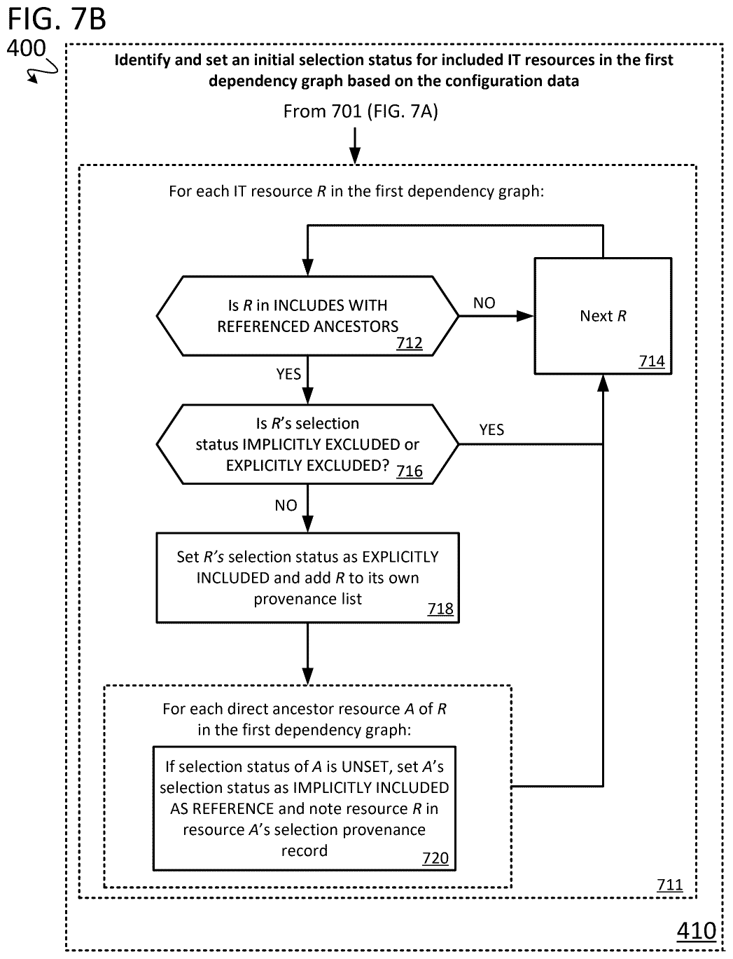

At step 410, the ITR controller 212 identifies and sets an initial selection status for each implicitly and explicitly included IT resource in the first dependency graph based on the INCLUDES and EXCLUDES configuration data. Details of step 410 are described below with reference to FIG. 7A and FIG. 7B.

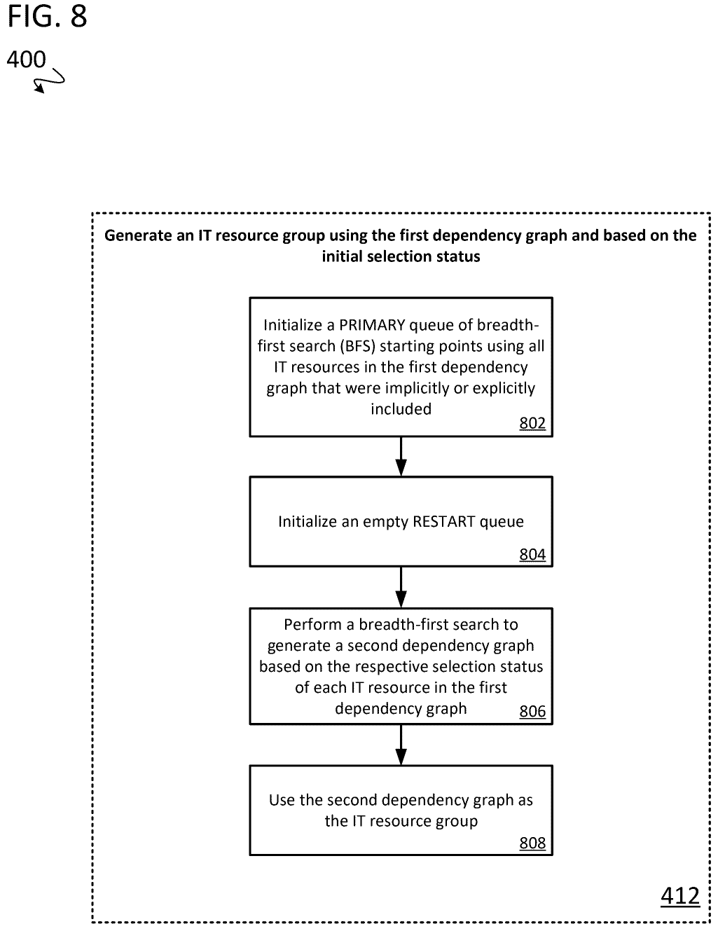

At step 412, the ITR controller 212 generates an IT resource group using the first dependency graph and based on the initial selection status of each IT resource within the first dependency graph. Details of step 412 are described below with reference to FIG. 8.

As illustrated by the dashed boxes in FIG. 4, process steps 414a-e are non-limiting example use-cases for managing and/or updating an IT infrastructure using generated IT resource groups. The use cases shown may be part of a process that precedes step 402, i.e., in the examples of 414a-b, or may proceed after step 412, i.e., in the examples of 414c-e. The non-limiting example use-cases include cloning IT infrastructure using the IT resource group 414a, performing domain demarcation using the IT resource group 414b, creating custom lists of IT resources using the IT resource group 414c, performing policy compliance checks using the IT resource group 414d, and performing IT infrastructure configuration drift detection using the IT resource group 414e. Each of the example use cases 414a-e is described in further detail below.

FIG. 5 illustrates an example of a simplified portion of a process that implements step 406 introduced in FIG. 4 for receiving INCLUDES and EXCLUDES configuration data, in accordance with some embodiments. The particular steps, order of steps, and combination of steps are shown for illustrative and explanatory purposes only. Other embodiments can implement different particular steps, orders of steps, and combinations of steps to achieve similar functions or results.

As part of receiving the INCLUDES and EXCLUDES configuration data, at step 502, the ITR controller 212 receives, from a user or another process, an EXCLUDES list of IT resources to be explicitly excluded from the first dependency graph when generating the IT resource group. At step 504, the ITR controller 212 receives, from a user or from another process, an INCLUDES list of IT resources to be explicitly included from the first dependency graph when generating the IT resource group. At step 506, the ITR controller 212 receives, from a user or from another process, an INCLUDES WITH REFERENCED ANCESTORS list of IT resources with referenced ancestors that should be explicitly included from the first dependency graph when generating the IT resource group. In some embodiments, the INCLUDES, EXCLUDES, and INCLUDES WITH REFERENCED ANCESTORS lists are implemented as one or more data objects that identify the relevant IT resources.

FIG. 6 illustrates an example of a simplified portion of a process that implements step 408 introduced in FIG. 4 for identifying and marking an initial selection status for excluded IT resources in the first dependency graph based on the INCLUDES and EXCLUDES configuration data, in accordance with some embodiments. The particular steps, order of steps, and combination of steps are shown for illustrative and explanatory purposes only. Other embodiments can implement different particular steps, orders of steps, and combinations of steps to achieve similar functions or results.

As shown, steps 602 through 608 are performed for each IT resource R in the first dependency graph that was generated at step 404 of the process 400. As each IT resource R in the first dependency graph is considered, at step 602 the ITR controller 212 determines whether that IT resource R appears in the EXCLUDES list that was received as part of the configuration data at step 406 of the process 400. If it is determined at step 602 that the IT resource R is not in the EXCLUDES list, flow of the process continues to step 604 to consider the next IT resource R in the first dependency graph, and then flow of the process returns to step 602. If it was determined at step 602 that the IT resource R is identified in the EXCLUDES list, at step 606 the ITR controller 212 sets the selection status data from the IT resource R to a value of EXPLICITLY EXCLUDED (e.g., in temporary data, in meta-data of the IT resource R, or in a database field or data object associated with the IT resource R). Step 608 is then conducted for each IT resource D in the first dependency graph that is a descendant IT resource of the IT resource R. At step 608, the ITR controller 212 sets the selection status data for the IT resource D to a value of IMPLICITLY EXCLUDED and additionally identifies the IT resource R in a provenance selection record (e.g., a list of IT resources) for the IT resource D. The provenance selection record may be stored in meta-data of the IT resource D or may be stored in a data object associated with the IT resource D. The provenance selection record is used by subsequent steps and reporting for the process 400 to indicate why a particular IT resource was excluded from the first dependency graph when generating the IT resource group. Flow of the process then returns to step 604 to consider the next IT resource R in the first dependency graph.

FIG. 7A illustrates an example of a simplified portion of a process that implements step 410 introduced in FIG. 4 for identifying and marking an initial selection status for implicitly and explicitly included IT resources in the first dependency graph based on the INCLUDES and EXCLUDES configuration data received at step 406, in accordance with some embodiments. The particular steps, order of steps, and combination of steps are shown for illustrative and explanatory purposes only. Other embodiments can implement different particular steps, orders of steps, and combinations of steps to achieve similar functions or results.

As shown, steps 702 through 710 are performed at step 701 for each IT resource R in the first dependency graph that was generated at step 404 of the process 400. As each IT resource R in the first dependency graph is considered, at step 702 the ITR controller 212 determines whether that IT resource R appears in the INCLUDES list that was received as part of the configuration data at step 406 of the process 400. If it is determined at step 702 that the IT resource R is not in the INCLUDES list, flow of the process continues to step 704 to consider the next IT resource R in the first dependency graph, and then flow of the process returns to step 702. If it was determined at step 702 that the IT resource R is identified in the INCLUDES list, at step 706 the ITR controller 212 further determines if the selection status data of the IT resource R was previously set (e.g., as part of step 408) to IMPLICITLY EXCLUDED or EXPLICITLY EXCLUDED. If the IT resource R has been previously excluded, flow of the process returns to step 704 to consider the next IT resource R in the first dependency graph. Otherwise, flow of the process continues to step 708. At step 708, the ITR controller 212 sets the selection status data from the IT resource R to a value of EXPLICITLY INCLUDED (e.g., in temporary data, in meta-data of the IT resource R, or in a database field or data object associated with the IT resource R) and adds R to its own provenance list. Step 710 is then conducted for each IT resource A in the first dependency graph that is an ancestor IT resource of the IT resource R. At step 710, if the selection status of a given ancestor resource A is UNSET, the ITR controller 212 sets the selection status data for that ancestor IT resource A to a value of IMPLICITLY INCLUDED and additionally identifies the IT resource R in a provenance selection record for the IT resource A. The provenance selection record may be stored in meta-data of the IT resource A or may be stored in a data object associated with the IT resource A. The provenance selection record is used by subsequent steps and reporting for the process 400 to indicate why a particular IT resource was included from the first dependency graph in the resource group. Flow of the process then returns to step 704 to consider the next IT resource R in the first dependency graph. When each of the IT resources R in the first dependency graph has been considered, flow of the process continues to step 711 shown in FIG. 7B.

FIG. 7B continues the example of a simplified portion of a process introduced in FIG. 7A for identifying and marking an initial selection status for implicitly and explicitly included IT resources in the first dependency graph based on the INCLUDES and EXCLUDES configuration data received at step 406, in accordance with some embodiments. The particular steps, order of steps, and combination of steps are shown for illustrative and explanatory purposes only. Other embodiments can implement different particular steps, orders of steps, and combinations of steps to achieve similar functions or results.

As shown, steps 712 through 720 are performed at step 711 for each IT resource R in the first dependency graph that was generated at step 404 of the process 400. As each IT resource R in the first dependency graph is considered, at step 712 the ITR controller 212 determines whether that IT resource R appears in the INCLUDES WITH REFERENCED ANCESTORS list that was received as part of the configuration data at step 406 of the process 400. If it is determined at step 712 that the IT resource R is not in the INCLUDES WITH REFERENCED ANCESTORS list, flow of the process continues to step 714 to consider the next IT resource R in the first dependency graph, and then flow of the process returns to step 712. If it was determined at step 712 that the IT resource R is identified in the INCLUDES WITH REFERENCED ANCESTORS list, at step 716 the ITR controller 212 further determines if the selection status data of the IT resource R was previously set (e.g., as part of step 408) to IMPLICITLY EXCLUDED or EXPLICITLY EXCLUDED. If the IT resource R has been previously excluded, flow of the process returns to step 714 to consider the next IT resource R in the first dependency graph. Otherwise, flow of the process continues to step 718. At step 718, the ITR controller 212 sets the selection status data from the IT resource R to a value of EXPLICITLY INCLUDED (e.g., in temporary memory, in meta-data of the IT resource R, or in a database field or data object associated with the IT resource R) and adds R to its own provenance list. Step 720 is then conducted for each IT resource A in the first dependency graph that is a direct ancestor IT resource of the IT resource R. At step 720, if the selection status of the IT resource A is UNSET, the ITR controller 212 sets the selection status data for the IT resource A to a value of IMPLICITLY INCLUDED AS REFERENCE and additionally identifies the IT resource R in a provenance selection record for the IT resource A. The provenance selection record may be stored in meta-data of the IT resource A or may be stored in a data object associated with the IT resource A. The provenance selection record is used by subsequent steps and reporting for the process 400 to indicate why a particular IT resource was included from the first dependency graph in the resource group. Flow of the process then returns to step 714 to consider the next IT resource R in the first dependency graph.

FIG. 8 illustrates an example of a simplified portion of a process that implements step 412 introduced in FIG. 4 for generating an IT resource group using the first dependency graph and based on the initial selection status set as part of steps 408 and 410, in accordance with some embodiments. The particular steps, order of steps, and combination of steps are shown for illustrative and explanatory purposes only. Other embodiments can implement different particular steps, orders of steps, and combinations of steps to achieve similar functions or results.

At step 802, the ITR controller 212 initializes a breadth-first search (BFS) PRIMARY queue using IT resources from the first dependency graph that were implicitly or explicitly included as starting points (i.e., root nodes). At step 804, the ITR controller 212 initializes an empty RESTART queue. As is understood in the art, a breadth-first search is a graph traversal algorithm used to explore nodes in a graph layer by layer, starting from a specified root node. In the context of a directed dependency graph, BFS systematically visits each node's direct neighbors before proceeding to the next level of dependencies. This approach ensures that all nodes at a given “depth” (or level of dependency) are processed before moving on to nodes that are further downstream.

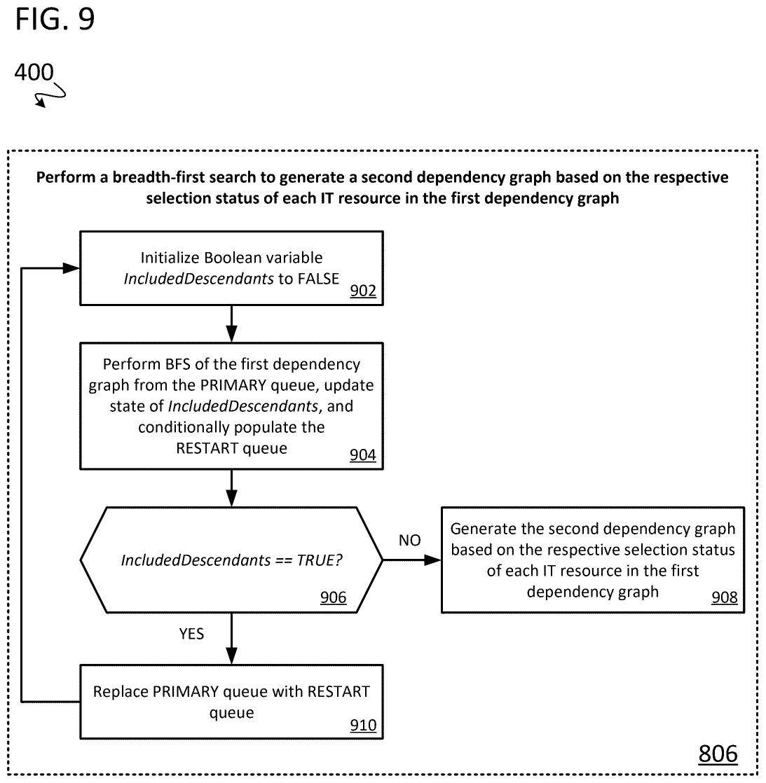

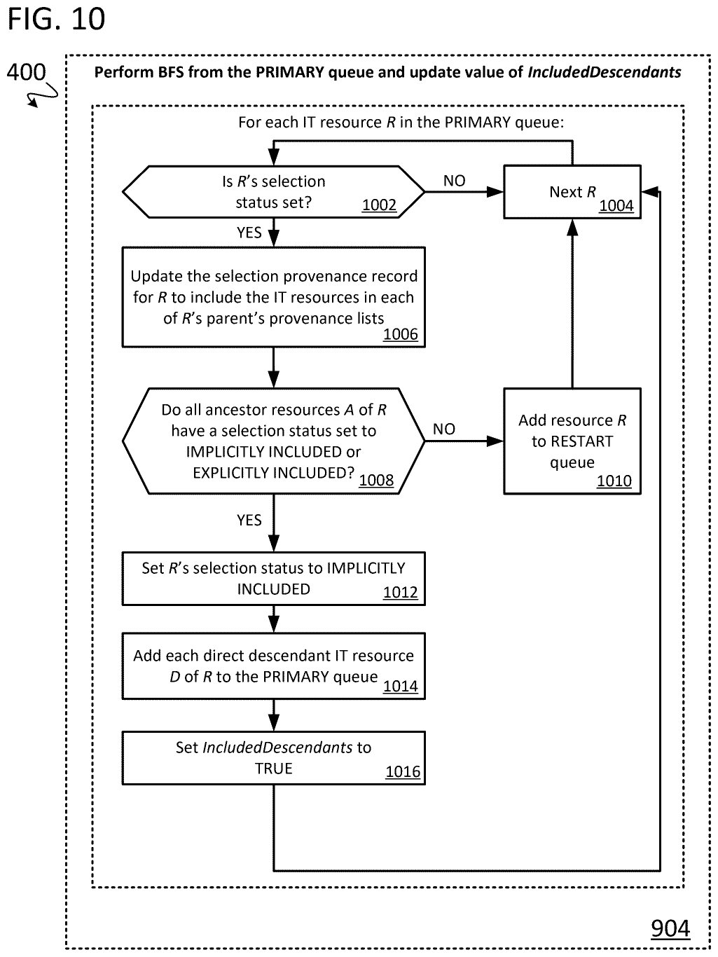

At step 806, the ITR controller 212 performs a breadth-first search using the PRIMARY queue and the RESTART queue to generate a second dependency graph of IT resources based on the respective selection status of each IT resource in the first dependency graph. The breadth-first search advantageously identifies and updates selection status and provenance data for each of the IT resources in the first dependency graph to ultimately generate a coherent set of IT resources. The breadth-first search advantageously adds descendants of included IT resources to the IT resource group as a convenience to the user while also ensuring that as the IT resources are added, a coherent set of IT resources is maintained (by only adding a descendant IT resource if doing so will not create a dangling reference). Details of step 806 are described below in detail with reference to FIG. 9 and FIG. 10.

At step 808, the ITR controller 212 uses the second dependency graph as, or as part of, the generated IT resource group.

FIG. 9 illustrates an example of a simplified portion of a process that implements step 806 introduced in FIG. 8 for performing a breadth-first search to generate a second dependency graph which is thereafter used as the IT resource group, in accordance with some embodiments. The particular steps, order of steps, and combination of steps are shown for illustrative and explanatory purposes only. Other embodiments can implement different particular steps, orders of steps, and combinations of steps to achieve similar functions or results.

At step 902, the ITR controller 212 initializes a Boolean variable IncludedDescendants to FALSE. At step 904, the ITR controller 212 performs a breadth-first search of the first dependency graph using the IT resources in the PRIMARY queue as root nodes. As part of step 904, the state of IncludedDescendants may be updated by the ITR controller 212 based on the search, and the RESTART queue may be populated with IT resources as part of the search. Details of step 904 are described in detail with reference to FIG. 10. At step 906 the ITR controller 212 determines if the Boolean variable IncludedDescendants was set to TRUE during step 904. If IncludedDescendants is TRUE, at step 910 the ITR controller 212 replaces the contents of the PRIMARY queue with the contents of the RESTART queue and then flow of the process returns to step 902. When it is determined at step 906 that no new descendants were identified during the search at 904 (i.e., the value of IncludedDescendants is FALSE), flow of the process continues to step 908. At step 908, the ITR controller 212 generates a second dependency graph based on the respective selection status of each IT resource in the first dependency graph which were set by the ITR controller 212 using the initial configuration data as part of steps 408 and 410 and thereafter by the breadth-first search as part of step 412.

In some embodiments, the second dependency graph is generated by adding IT resources from the first IT dependency graph that have a selection status of included (implicit or explicit) and omitting IT resources from the first IT dependency graph from the first IT dependency graph that have a selection status of excluded (implicit or explicit). In other embodiments, the second dependency graph includes at least the IT resource from the first IT dependency graph, but the respective selection status of each IT resource is used to indicate whether a given IT resource is part of the IT resource group or is omitted therefrom. As mentioned above, the second dependency graph is thereafter used as the IT resource group.

FIG. 10 illustrates an example of a simplified portion of a process that implements step 904 introduced in FIG. 9 for performing a breadth-first search of the first dependency graph, updating the state of IncludedDescendants, and conditionally populating the RESTART queue, in accordance with some embodiments. The particular steps, order of steps, and combination of steps are shown for illustrative and explanatory purposes only. Other embodiments can implement different particular steps, orders of steps, and combinations of steps to achieve similar functions or results.

As shown, steps 1002 through 1018 are performed for each IT resource R in the PRIMARY queue (e.g., until the PRIMARY queue is empty). As each IT resource R in the PRIMARY queue is considered (e.g., popped off of the PRIMARY queue), at step 1002 the ITR controller 212 determines if the selection status of the IT resource R has been set (i.e., it does not have a value of UNSET). If the selection status of the IT resource R is not set, then flow of the process continues to step 1004 to consider the next IT resource R in the PRIMARY queue (e.g., the next IT resource R is popped off the queue for consideration), and then flow returns to step 1002.

If it was determined at step 1002 that the selection status of the IT resource R has been set to a value other than UNSET, at step 1006 the ITR controller 212 updates the selection provenance record for R such that the provenance record includes the IT resources in each R's parent's respective provenance lists.

At step 1008, the ITR controller 212 determines whether each of the identified ancestor IT resources A of the IT resource R has a selection status that is set to either IMPLICITLY INCLUDED or EXPLICITLY INCLUDED. If that criterion is not met, flow of the process continues to step 1010, whereupon the ITR controller 212 adds the IT resource R to the RESTART queue (e.g., pushes it onto the RESTART queue) for subsequent processing. Flow then continues to step 1004 for the next IT resource R to be considered as the process returns to step 1002.

If instead it was determined at step 1008 that each of the IT resources A has a selection status that is set to IMPLICITLY INCLUDED or EXPLICITLY INCLUDED, flow of the process continues to step 1012. At step 1012, the ITR controller 212 sets the selection status for the IT resource R to IMPLICITLY INCLUDED. At step 1014, the ITR controller 212 adds (e.g., pushes) each direct descendent IT resource D of the IT resource R to the PRIMARY queue for subsequent processing. At step 1016, the ITR controller 212 sets the Boolean value IncludedDescendants to TRUE, and then flow of the process continues to step 1004 to process the next IT resource R in the PRIMARY queue.

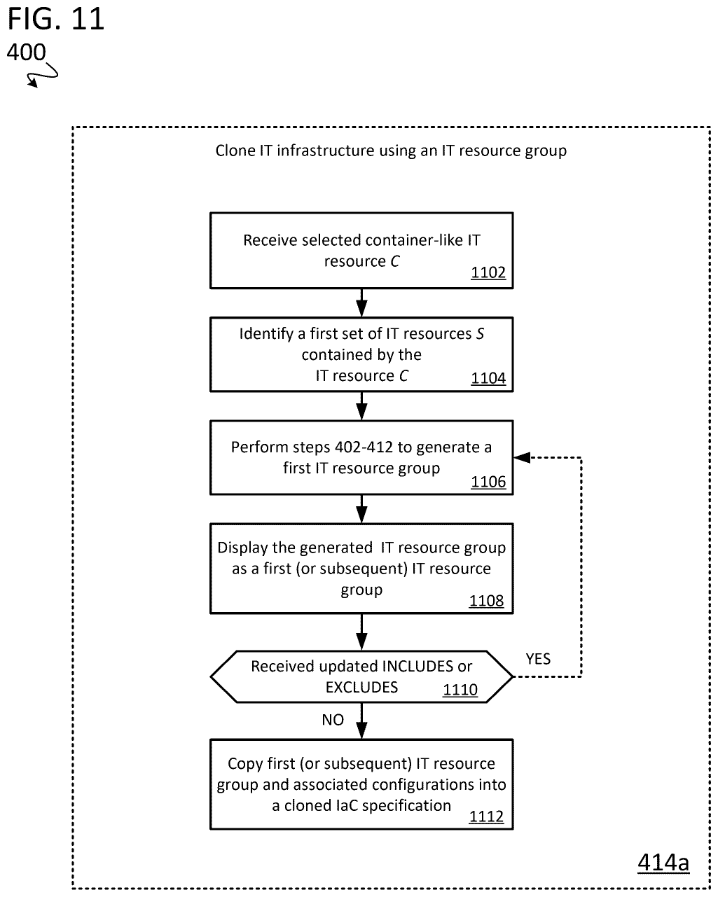

As mentioned above, several non-limiting example use cases 414a-e are introduced in FIG. 4. As a first example use case for IT resource groups, FIG. 11 illustrates an implementation of step 414a for cloning IT infrastructure using an IT resource group, in accordance with some embodiments. The particular steps, order of steps, and combination of steps are shown for illustrative and explanatory purposes only. Other embodiments can implement different particular steps, orders of steps, and combinations of steps to achieve similar functions or results.

In some scenarios, a user may want to clone a set of IT resources (e.g., one or more VPCs, the subnets and virtual machines that the VPCs contain, the VPC peering connections, Internet Gateways, and/or VPN connections providing network connectivity for those VPCs). Cloning a set of IT resources may be useful for a variety of reasons, such as creating a replica of a production environment for development and testing, or for making a backup replica of the production environment in a different geographic region in case the primary region fails (i.e., disaster recovery).

However, such IT infrastructure environments can be large, comprising thousands or more IT resources. Forcing the user to explicitly list all of the IT resources that should be cloned is tedious and error prone. Applying the techniques disclosed herein makes the process easier and more reliable as compared to conventional techniques. The steps described with reference to FIG. 11 assume that the user has already provided the ITR controller 212 with sufficient account credentials to access any IT resources of interest and that the ITR controller 212 has identified the IT resources associated with the credentialed account.

At step 1102, the ITR controller 212 receives one or more selected (e.g., by a user or as part of another process) IT resource(s) C of interest that is container-like. Examples of container-like IT resources are resource groups, virtual machines (VMs), VPCs, and VNets. At step 1104, the ITR controller 212 identifies a set of IT resources S that are contained by the IT resource C (e.g., using techniques described in the '234 patent incorporated by reference above). At step 1106, steps 402-412 shown in FIG. 4 are performed by the ITR controller 212 using the set S of IT resources as the data identifying the first set of IT resources at step 402. The user may also optionally provide the INCLUDES and EXCLUDES configuration data used at step 406. As described above, the output of step 412 is an IT resource group, which is used by the ITR controller 212 as a first IT resource group.

At step 1108, the ITR controller 212 generates a graphical display of the first IT resource group for review and modification by the user. Based on user input, at step 1110, the ITR controller 212 determines if the user has updated the INCLUDES or EXCLUDES selection status of any IT resource of the first IT resource group. For example, in some embodiments, the first IT resource group may be graphically displayed in a list or table format with ephemeral check box user interface elements that display a current selection status for a given IT resource and also that allow a user to modify a respective selection status.

If one or more selection status values for the IT resources of the first IT resource group are determined to have been modified at step 1110, flow returns to step 1106, in which steps 402-412 are performed again by the ITR controller 212 using the updated INCLUDES and EXCLUDES configuration data.

When it is determined at step 1110 that no updates to the INCLUDES or EXCLUDES have been received from a user, flow continues to step 1112. At step 1112, the ITR controller 212 copies the first, or a subsequently generated IT resource group and associated configurations of the IT resources thereof into a cloned IaC specification which may thereafter be used to generate the cloned IT infrastructure.

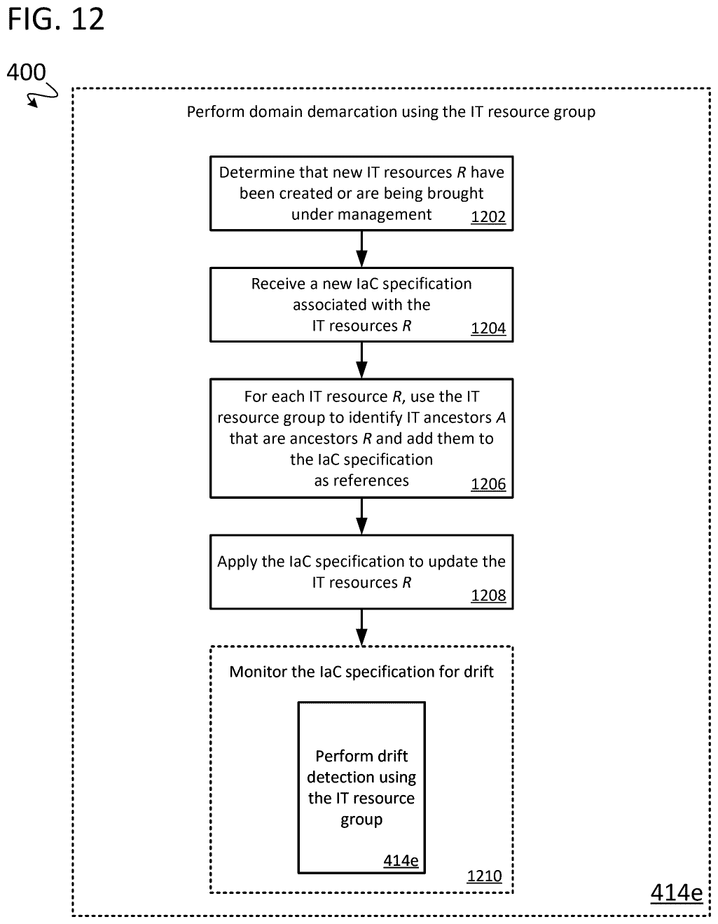

As a second example use case for IT resource groups, FIG. 12 illustrates an implementation of step 414e for performing domain demarcation using an IT resource group, in accordance with some embodiments. The particular steps, order of steps, and combination of steps are shown for illustrative and explanatory purposes only. Other embodiments can implement different particular steps, orders of steps, and combinations of steps to achieve similar functions or results.

Large organizations often have multiple IaC configurations/pipelines responsible for managing different parts of their IT infrastructure (e.g., an infrastructure team responsible for provisioning accounts, VPCs, and networking, and an application team responsible for provisioning VMs or groups of nodes that run containerized applications).

In some scenarios, an administrator may use a software application to manage part of an organization's infrastructure (like VPN gateways and other resources related to network connectivity) and use that organization's in-house IaC toolchain to deploy the rest of the organization's IT infrastructure.

In these scenarios, it is often important to have clear demarcation boundaries, e.g., “we're responsible for these resources, and you're responsible for those resources.” If the same IT resource appears in more than one configuration then there are multiple “sources of truth” fighting over how the IT resource should be configured. The process 400 for generating IT resource groups may advantageously be used to define multiple different sets of IT resources that are managed by respective groups within an organization.

Furthermore, in such scenarios, it is often important that each team's IaC configuration for their IT resource set be deployable. Therefore, the process 400 described with reference to FIG. 4 may be advantageously used to keep coherent sets of IT resources together by automatically including/excluding IT resources based on the INCLUDES and EXCLUDES configuration data described above. As such, administrators may advantageously maintain distinct, coherent, sets of IT resources that are within their jurisdiction (i.e., “we're not responsible for anything past this point.”)

In particular, the ability to include an IT resource with referenced ancestor IT resources is important to domain demarcation. This is because an administrator team Y might deploy IT resources that depend on IT resources managed by team X. For example, team Y may deploy application VMs inside a VPC deployed by team X. In order to maintain a coherent set of IT resources, team Y's IaC specification will need references to the IT resources managed by team X.

Additionally, in some general scenarios, when an IT infrastructure management application creates new IT resources in a cloud network, the user of that management application likely intends that the management application be responsible for maintaining the new IT resources and not any of the surrounding IT resources. For example, a user may deploy and manage a VPN gateway but not want to assume management responsibility for the VPC into which the VPN gateway was placed. As another example, a user may create a network security group (NSG), which is essentially a cloud-network firewall application. Upon deploying the NSG, the user may need to keep the configuration rules for the deployed NSG up to date (including identifying out-of-band changes to those rules). However, the user may not need to manage the subnet(s) within the cloud-network which uses the NSG.

Returning attention to FIG. 12, a high-level example illustrating domain demarcation using IT resource groups generated as part of the process 400 begins at step 1202. At step 1202, the ITR controller 212 determines that new IT resources R have either been created or are being brought under management by the ITR controller 212 or an associated IT management application. At step 1204, the ITR controller 212 receives a new IaC specification that is associated with the new IT resources R (from a user or from another process). At step 1206, for each of the IT resources R, the ITR controller 212 uses the IT resource group generated by the process 400 to identify ancestor IT resources A of that IT resource R and add the IT resources A to the IaC specification as references (i.e., read-only data objects). At step 1208, the ITR controller 212 applies the IaC specification to update the IT resources R. The ITR controller may then use the IT resource group to manage the associated IT infrastructure—for example, at step 1210 to monitor the IaC specification for drift using steps described with reference to the example process 414e introduced in FIG. 4.

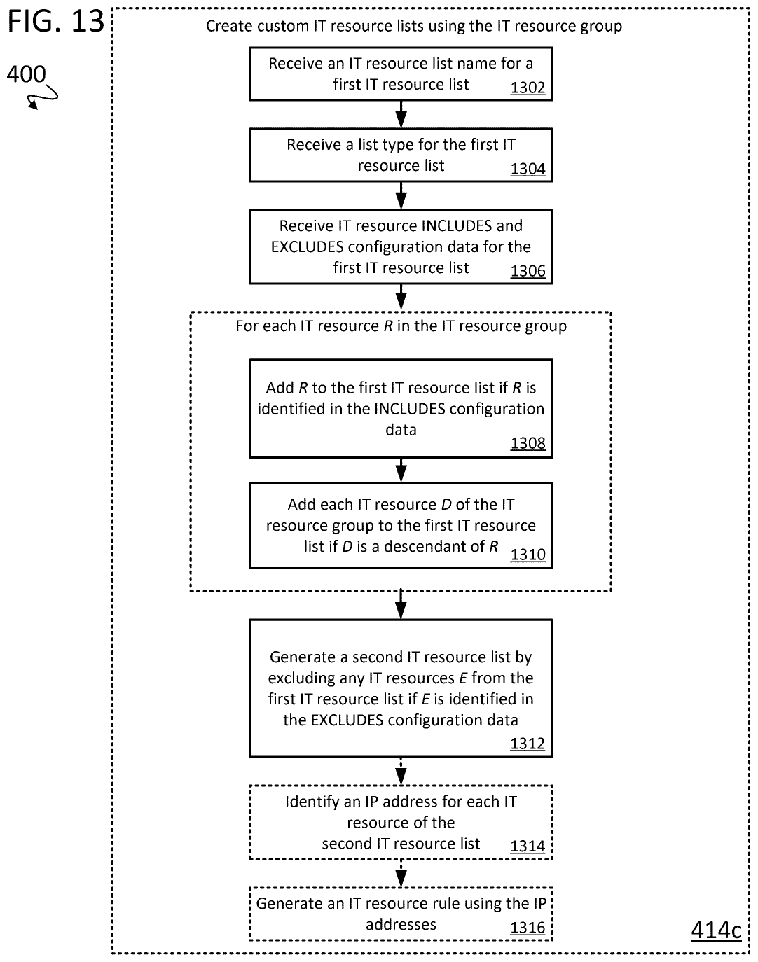

As a third example use case for resource groups, FIG. 13 illustrates an implementation of step 414c for creating custom IT resource lists using an IT resource group, in accordance with some embodiments. The particular steps, order of steps, and combination of steps are shown for illustrative and explanatory purposes only. Other embodiments can implement different particular steps, orders of steps, and combinations of steps to achieve similar functions or results.

At step 1302 the ITR controller 212 receives an IT resource list name for a first IT resource list from a user or another process. At step 1304, the ITR controller 212 receives an IT resource list type from the user or the other process step. At step 1306, the ITR controller 212 receives INCLUDES and EXCLUDES configuration data to be applied by the ITR controller 212 when generating the first IT resource list. Steps 1308 and 1310 are then performed for each IT resource R of the IT resource group. At step 1308, if the ITR controller 212 determines that the IT resource R is identified in the INCLUDES configuration data received at step 1306, the IT resource R is added to the first IT resource list. At step 1310, the ITR controller 212 identifies each IT resource D in the IT resource group that is a descendant of R and adds the IT resource D to the first IT resource list.

After each of the IT resources R of the IT resource group has been considered by the ITR controller 212, flow continues to step 1312. At step 1312, the ITR controller 212 generates a second IT resource list by excluding (e.g., removing or flagging) any IT resources E from the first IT resource list if E is identified in the EXCLUDES configuration data.

The second IT resource list may thereafter be used by the ITR controller 212 or another system as part of additional process steps. For example, some software applications for IT infrastructure management offer a feature whereby a user may create a list of IP addresses and subsequently use that list across various IT infrastructure management applications. For example, firewall rules for a firewall application (e.g., the rules 221-225 for the firewall application 220 shown in FIG. 2) can reference a custom list to block or allow connections from all applications in the list.

In some scenarios, a user may have virtual machines or containers deployed in a cloud that they would like to treat as a group from the perspective of products, such as the firewall application. In such scenarios, a user may prefer to create a firewall rule such as, to paraphrase, “allow inbound traffic from any VM in my cloud network account tagged ‘prod-db-server”. However, virtual machine and container instances in cloud environments tend to be more ephemeral than physical servers; they are often created or destroyed in response to increased or decreased demand. This makes it tedious and error-prone to maintain up-to-date lists of their IP addresses since that list must frequently change.

Therefore, the process 400 shown in FIG. 4 may be used in conjunction with steps 1304-1312 shown in FIG. 13 to allow a user to specify query expressions to define groups of container IT resources (e.g., “all VMs with the tag ‘prod-db-server”), which may be expressed as INCLUDES and EXCLUDES configuration data, and add those IT resources and descendants thereof to an IT resource list.

The ITR controller 212 is further operable to post-process the IT resources list to generate input configuration data for IT infrastructure management applications, such as the firewall example discussed above. In this example, at an optional step 1314, the ITR controller 212 identifies a respective IP address for each IT resource of the second resource list, and then at step 1316 generates an IT resource rule (e.g., for the firewall application) using the identified IP addresses.

In some embodiments, the ITR controller 212 may subsequently monitor the user's IT resources for: (a) new IT resources matching the initial query, (b) the disappearance of IT resources previously matching the query, and (c) changes to IT resources matching the query. In response to such a change, the ITR controller 212 will advantageously update the IT resource rule with the current IP addresses for the IT resources matching the query.

Additionally, the “Automatic inclusions/exclusions” feature using INCLUDES and EXCLUDES configuration data is operable to express queries defining groups of IT resources more powerfully than conventional solutions. For example, in some scenarios, an administrator using an IT infrastructure application may want to create an IT infrastructure management rule based on tags, but would like to define a group as follows: “any VMs in (i.e., children of) VPC X but not in (i.e., children of) subnet Y.” Unfortunately, this relationship cannot be expressed using tags since this rule is based on IT resource dependency relationships. However, using the process 400 and subsequently the process step 414c, the user may advantageously generate INCLUDES and EXCLUDES configuration data based on the desired query and subsequently generate an IT resource list.

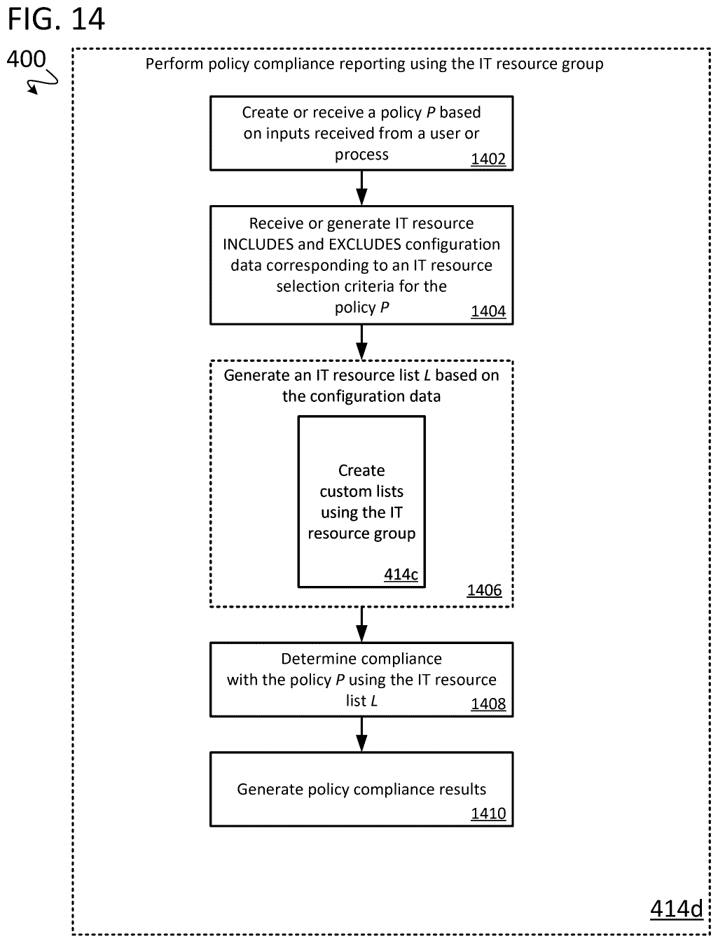

As a fourth example use case for resource groups, FIG. 14 illustrates an implementation of step 414d for performing policy compliance using the IT resource group, in accordance with some embodiments. The particular steps, order of steps, and combination of steps are shown for illustrative and explanatory purposes only. Other embodiments can implement different particular steps, orders of steps, and combinations of steps to achieve similar functions or results.

Some IT infrastructure management applications include a feature for scanning IT infrastructure and services (e.g., SaaS services) and thereafter generating reports on any detected policy violations. For example, a policy might flag cloud network folders shared with users outside the user's organization as a policy violation of the organization. Policies typically capture security requirements, but could also check for other violations, such as unintended spending within the IT infrastructure.

When such policy checking is applied to distributed cloud networks, the user's policies defining what constitutes a policy violation will also be more varied as compared to policy checking for a single application or network. Even within a single cloud account, a user may prefer that different policies be applied to different groups of IT resources (e.g., “a VPC hosting an internal service should not be connected to the public Internet whereas a VPC hosting an external service should be”). This means that the first step to writing a policy for cloud-based IT resources is often to specify which IT resources the policy should be applied to.

Another characteristic of cloud networking environments is that cloud-based IT resources are often ephemeral. That is, developers can create new IT services quickly since network and compute resources can be provisioned with just a few clicks; and even once running, a service's VMs/containers can be spun up/down in response to demand. As disclosed herein, this means that IT resource selection must advantageously be dynamic.

To elaborate, a conventional policy checker that relies on a static list of IT resource names or IDs may not be useful because it will only flag violations for IT resources that a user remembered to add to the list. Unfortunately, if a user remembered to add an IT resource to the list, the user probably already knows that the IT resource is policy-compliant. Therefore, it is advantageous to identify policy violations created by developers who may not be considering security policies.

In some scenarios, simple queries based on an IT resource type or tags are sufficient (e.g., “any VPC without the ‘public’ tag should not have an Internet Gateway”). But in other cases, a user may want to fine-tune an IT resource selection query based on dependency graph relationships generated as part of the process 400 shown in FIG. 4.

For example, a user that needs to implement an internal service using a cloud-networking service that spans multiple VNets, the user could advantageously group all the VNets in one resource group named “internalServiceResourceGroup” and then create a policy that enforces “any VNet in internalServiceResourceGroup should not have a NAT Gateway” (which would enable public Internet access). An example pseudo-code IT resource selection query for this policy might state:
DESCENDANTS(internalServiceResourceGroup) AND type==“vnet”

However, if the internal service needs to query a third-party service on the Internet (e.g., a mapping service to translate addresses into latitude and longitude, as but one example), the user may isolate the IT resource that the internal service needs to a single VNet and then give that VNet a NAT gateway. The user may then update the IT selection query so that the “no NAT Gateway” policy does not apply to that VNet or its children, e.g.:
DESCENDANTS(internalServiceResourceGroup.id) AND type==“vnet” EXCLUDE(exempt_vnet.id)

Returning attention to FIG. 14, a high-level example of policy compliancy reporting using the IT resource group generated as part of the process 400 begins at step 1402. At step 1402, the ITR controller 212 identifies (e.g., generates or receives) an IT infrastructure policy P based on input received from a user or another process. At step 1404, the ITR controller 212 identifies (e.g., generates or receives) INCLUDES and EXCLUDES configuration data corresponding to an IT resource selection query for the policy P (e.g., which may be similar to the example selection queries described above). At step 1406, the ITR controller 212 generates an IT resource list L based on the INCLUDES and EXCLUDES configuration data using steps that are the same or that are similar to those described with reference to step 414c introduced in FIG. 4.

At step 1408, the ITR controller 212, the IaC platform 205, or another module, determines if the policy P is satisfied based on the state and configuration of the IT resources in the list L. At step 1410, the policy compliance results generated at step 1408 may be reported to a user or another module or process and/or be used to update the IT infrastructure in accordance with the policy P.

In some embodiments, the process step 414d may be performed each time an IT resource catalog is updated or a policy is updated or created. Additionally, the process step 414d may be performed periodically, or in response to a detected event.

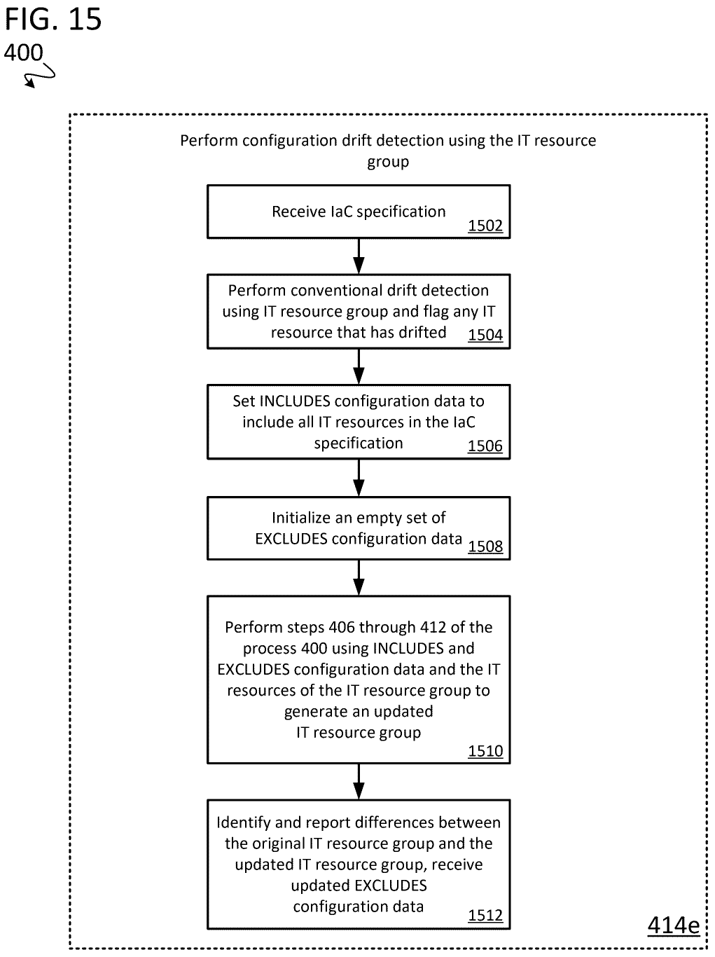

As a fifth example use case for resource groups, FIG. 15 illustrates an implementation of step 414e for performing configuration drift detection using the IT resource group, in accordance with some embodiments. The particular steps, order of steps, and combination of steps are shown for illustrative and explanatory purposes only. Other embodiments can implement different particular steps, orders of steps, and combinations of steps to achieve similar functions or results.

As is known in the art, “drift detection” conventionally involves flagging and/or reversing out-of-band (OOB) changes (sometimes referred to as “shadow IT”) to resources in an IaC configuration. Such changes are conventionally tracked for IT resources that are already part of the IaC configuration as they are modified or destroyed. However, it's also useful to flag new IT resources that “should be” part of the configuration as they are created OOB.

For example, a user may deploy a VPC with one subnet, and one VM in that subnet, using IaC. If there is an OOB change to either the subnet or the VM, a conventional drift detection application will identify the change because the application will determine that there is a difference between the subnet's/VM's configuration in the IaC specification versus its live configuration. However, if a second subnet was added to the VPC OOB, this would not be conventionally flagged as drift because the new subnet is a new IT resource, i.e., the conventional drift detection application does not have a configuration in the IaC spec to compare against.

An additional challenge in flagging OOB creation of new IT resources as drift involves determining whether the new IT resource is relevant to a given IaC specification. For example, different teams within an organization may have their own IaC specifications for different projects. Thus, when team X deploys a new IT resource in the organization's cloud-network account, the IT resource should not necessarily be flagged as drift to team Y.

Thus, as disclosed herein, IT resource groups may be advantageously used to solve the challenge of determining if a new IT resource is “relevant” to an IaC specification by using the criteria described above for keeping coherent sets of IT resources together and using automatic inclusion/exclusion of IT resources. With regard to keeping coherent sets of IT resources together, if the existence of the new IT resource causes the IT resource configuration to no longer be a coherent set, the IT resource may be treated as being relevant to drift detection and be flagged as IaC specification drift. With regard to the automatic inclusion/exclusion of IT resources, if the new IT resource is a direct descendant of an IT resource in the IaC specification, the new IT resource may be relevant to drift detection and flagged as IaC specification drift.

In some embodiments, if an IT resource is flagged as IaC specification drift but a user disagrees, the user may explicitly mark that IT resource as excluded. Thereafter, the drift detection system will no longer flag that IT resource (or its descendants) as drift for that IaC specification.

Returning attention to FIG. 15, a high-level example of drift detection using the IT resource group generated as part of the process 400 begins at step 1502. At step 1502, the ITR controller 212 receives an IaC specification from a user or another module or process. At step 1504, the ITR controller 212 performs conventional drift detection using the originally received IT resource group and flags any IT resource that is associated with drift from the received IaC specification. At step 1506, the ITR controller 212 sets new INCLUDES configuration data to include each of the IT resources referenced in the IaC specification. At step 1508, the ITR controller 212 initializes an empty set of new EXCLUDES configuration data. At step 1510, the ITR controller 212 performs steps 406 through 412 of the process 400 using the new INCLUDES configuration data and the IT resources of the originally received IT resource group (i.e., from the process 400 preceding step 414e) to generate an updated IT resource group based on the new INCLUDES configuration data. At step 1512, the ITR controller 212 then compares the originally received IT resource group to the updated IT resource group to determine and report any differences therebetween which may be indicative of drift from the IaC specification. As mentioned above, if a user decides that a particular IT resource should not be considered as drift, that IT resource can be added to the EXCLUDES configuration data and used in subsequent iterations of step 414e.

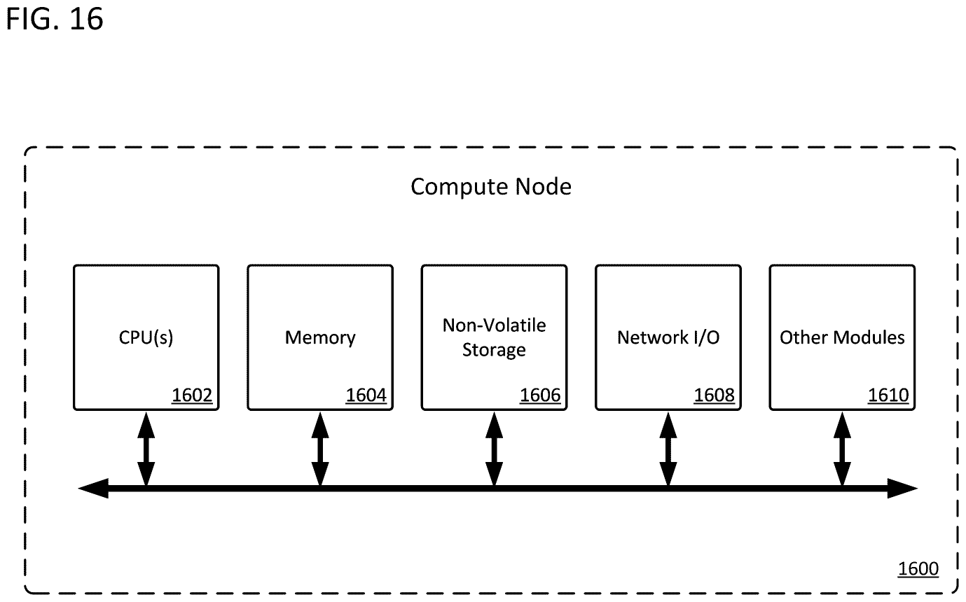

FIG. 16 illustrates an example compute node 1600, in accordance with some embodiments. In some embodiments, the one or more compute nodes 210 are the same as or similar to the compute node 1600. The compute node 1600 generally includes one or more CPUs 1602, a memory module 1604 (e.g., RAM), a non-volatile data storage module 1606 (e.g., a hard drive or array of hard drives), a network I/O module 1608 (e.g., a network interface card (NIC) and/or a top-of-rack interface), and other modules 1610 such as user I/O, wireless communication modules, optical communication modules, system diagnostic or monitoring modules, or other modules. In some embodiments, the compute node 1600 is configured to perform all or a portion of the process steps discussed with reference to the processes disclosed herein. The non-volatile data storage module 1606, thus, stores data and several programs for some or all of the above-described functions and process steps, among others. The data and programs are loaded into the memory module 1604, so that the one or more CPUs 1602 (in conjunction with the memory module 1604) can perform some or all of the above-described functions and process steps, among others. In some embodiments, the CPUs 1602 are shared or dedicated CPUs. These CPUs could perform a single network function, perform multiple network functions, or perform other tasks in addition to performing network functions. Examples of the CPUs 1602 include microprocessors, digital signal processors, microcontrollers, and dedicated hardware such as ASICs (Application Specific Integrated Circuits) and FPGAs (Field Programmable Gate Arrays).

Reference has been made in detail to embodiments of the disclosed invention, one or more examples of which have been illustrated in the accompanying figures. Each example has been provided by way of explanation of the present technology, not as a limitation of the present technology. In fact, while the specification has been described in detail with respect to specific embodiments of the invention, it will be appreciated that those skilled in the art, upon attaining an understanding of the foregoing, may readily conceive of alterations to, variations of, and equivalents to these embodiments. For instance, features illustrated or described as part of one embodiment may be used with another embodiment to yield a still further embodiment. Thus, it is intended that the present subject matter covers all such modifications and variations within the scope of the appended claims and their equivalents. These and other modifications and variations to the present invention may be practiced by those of ordinary skill in the art, without departing from the scope of the present invention, which is more particularly set forth in the appended claims. Furthermore, those of ordinary skill in the art will appreciate that the foregoing description is by way of example only, and is not intended to limit the invention.

What is claimed is:

1. A method, comprising:
receiving, by one or more processors, data identifying a set of information technology (IT) resources of an IT infrastructure;
generating, by the one or more processors, a first IT resource dependency graph using the set of IT resources;
receiving, by the one or more processors, first INCLUDES and EXCLUDES configuration data indicating one or more IT resources that should either be included or excluded from an IT resource group;
identifying and setting, by the one or more processors, an initial selection status for IT resources in the first dependency graph based on the first INCLUDES and EXCLUDES configuration data;
performing, by the one or more processors, a breadth-first search of the first dependency graph to generate the IT resource group based on the initial selection status for the IT resources in the first dependency graph; and
updating or managing, by the one or more processors, the IT infrastructure using the IT resource group.

2. The method of claim 1, wherein receiving the first INCLUDES and EXCLUDES configuration data comprises:
receiving, by the one or more processors, an EXCLUDES list of IT resources to be explicitly excluded from the first dependency graph;
receiving, by the one or more processors, an INCLUDES list of IT resources to be explicitly included in the first dependency graph; and
receiving, by the one or more processors, an INCLUDES WITH REFERENCED ANCESTORS list of IT resources with referenced ancestors to be explicitly included in the first dependency graph.

3. The method of claim 2, wherein identifying and setting an initial selection status for IT resources in the first dependency graph comprises:
determining, by the one or more processors, that a first IT resource of the first dependency graph is identified in the EXCLUDES list of IT resources;
setting, by the one or more processors, a selection status of the first IT resource to EXPLICITLY EXCLUDED;
identifying, by the one or more processors, a descendant IT resource of the first IT resource in the first dependency graph; and
setting, by the one or more processors, a selection status of the descendant IT resource to IMPLICITLY EXCLUDED and referring to the first IT resource in a provenance selection status of the descendant IT resource.

4. The method of claim 3, wherein identifying and setting an initial selection status for IT resources in the first dependency graph further comprises:
determining, by the one or more processors, that a second IT resource of the first dependency graph is identified as an included IT resource in the first INCLUDES and EXCLUDES configuration data;
determining, by the one or more processors, that the selection status of the second IT resource is not set to an excluded state;
setting, by the one or more processors, the selection status of the second IT resource to EXPLICITLY INCLUDED;
identifying, by the one or more processors, an ancestor IT resource of the second IT resource in the first dependency graph; and
setting, by the one or more processors, a selection status of the ancestor IT resource to an included state and referring to the second IT resource in a provenance selection status of the ancestor IT resource.

5. The method of claim 1, wherein generating the IT resource group based on the initial selection status for the IT resources in the first dependency graph comprises:
initializing, by the one or more processors, a primary queue of breadth-first search (BFS) starting points using all of the IT resources of the first dependency graph having a selection status of included;
initializing, by the one or more processors, and empty BFS restart queue; and
performing, by the one or more processors, a BFS of the first dependency graph using the primary queue to generate a second dependency graph based on a respective selection status of each IT resource in the first dependency graph, the second dependency graph being used as the IT resource group.

6. The method of claim 5, wherein performing a BFS of the first dependency graph comprises:
identifying, by the one or more processors, a selection status for each IT resource in the first dependency graph; and
conditionally adding or removing, by the one or more processors, ancestor and descendent IT resources for a given IT resource to the second dependency graph based on the selection status for that IT resource.

7. The method of claim 1, further comprising:
receiving, by the one or more processors, an identifier for an IT resource container;
identifying, by the one or more processors, a set of IT resources contained by the IT resource container;
using, by the one or more processors, the identified set of IT resources as the first set of IT resources used to generate the IT resource group;
generating, by the one or more processors, an IT infrastructure specification based on the generated IT resource group; and
updating, by the one or more processors, the IT infrastructure based on the IT infrastructure specification.

8. The method of claim 1, further comprising:
identifying, by the one or more processors, a first IT resource that was not in the first set of IT resources;
receiving, by the one or more processors, an IT infrastructure specification associated with the first IT resource;
identifying, by the one or more processors, a second IT resource in the first dependency graph that is an ancestor of the first IT resource;
adding, by the one or more processors, the second IT resource to the IT infrastructure specification to generate an updated IT infrastructure specification; and
applying, by the one or more processors, the updated IT infrastructure specification to the second IT resource.

9. The method of claim 1, further comprising:
receiving, by the one or more processors, second INCLUDES and EXCLUDES configuration data for generating a first IT resource list;
adding, by the one or more processors, a first IT resource of the IT resource group to the first IT resource list upon determining that the first IT resource is identified in the second INCLUDES configuration data;
adding, by the one or more processors, a second IT resource of the IT resource group to the first IT resource list upon determining that the second IT resource is a descendant of the first IT resource; and
generating, by the one or more processors, a second IT resource list by excluding a third IT resource from the first IT resource list upon determining that the third IT resource is identified in the second EXCLUDES configuration data.

10. The method of claim 9, further comprising:
identifying, by the one or more processors, an IP address for each IT resource in the second IT resource list;
generating, by the one or more processors, an IT resource rule based on the identified IP addresses; and
updating, by the one or more processors, the IT infrastructure based on the IT resource rule.

11. The method of claim 1, further comprising:
identifying, by the one or more processors, an IT infrastructure policy for the IT infrastructure;
identifying, by the one or more processors, second INCLUDES and EXCLUDES configuration data corresponding to an IT resource selection criteria for the IT infrastructure policy;
generating, by the one or more processors, an IT resource list using the IT resource group and the second INCLUDES and EXCLUDES configuration data;
determining, by the one or more processors, an IT policy compliance of the IT resources of the IT resource list based on the IT infrastructure policy;
generating, by the one or more processors, IT policy compliance results; and
updating, by the one or more processors, the IT infrastructure based on the IT policy compliance results.

12. The method of claim 1, further comprising:
receiving, by the one or more processors, an IT infrastructure specification;
generating, by the one or more processors, second INCLUDES configuration data based on IT resources included in the IT infrastructure specification;
generating, by the one or more processors, a second IT resource group and updated EXCLUDES configuration data using the first IT resource group and based on the second INCLUDES configuration data;
identifying, by the one or more processors, differences between the first IT resource group and the second IT resource group; and
updating, by the one or more processors, the IT infrastructure based on the identified differences between the first IT resource group and the second IT resource group.

13. A non-transitory computer-readable medium storing instructions for executing a computer-implemented method, the computer-implemented method comprising:
receiving, by one or more processors, data identifying a set of information technology (IT) resources of an IT infrastructure;
generating, by the one or more processors, a first IT resource dependency graph using the set of IT resources;
receiving, by the one or more processors, first INCLUDES and EXCLUDES configuration data indicating one or more IT resources that should either be included or excluded from an IT resource group;
identifying and setting, by the one or more processors, an initial selection status for IT resources in the first dependency graph based on the first INCLUDES and EXCLUDES configuration data;
performing, by the one or more processors, a breadth-first search of the first dependency graph to generate the IT resource group based on the initial selection status for the IT resources in the first dependency graph; and
updating or managing, by the one or more processors, the IT infrastructure using the IT resource group.

14. The non-transitory computer-readable medium of claim 13, wherein generating the IT resource group based on the initial selection status for the IT resources in the first dependency graph comprises:
initializing, by the one or more processors, a primary queue of breadth-first search (BFS) starting points using all of the IT resources of the first dependency graph having a selection status of included;
initializing, by the one or more processors, and empty BFS restart queue; and
performing, by the one or more processors, a BFS of the first dependency graph using the primary queue to generate a second dependency graph based on a respective selection status of each IT resource in the first dependency graph, the second dependency graph being used as the IT resource group.

15. The non-transitory computer-readable medium of claim 14, wherein performing a BFS of the first dependency graph comprises:
identifying, by the one or more processors, a selection status for each IT resource in the first dependency graph; and
conditionally adding or removing, by the one or more processors, ancestor and descendent IT resources for a given IT resource to the second dependency graph based on the selection status for that IT resource.

16. The non-transitory computer-readable medium of claim 13, the computer-implemented method further comprising:
receiving, by the one or more processors, an identifier for an IT resource container;
identifying, by the one or more processors, a set of IT resources contained by the IT resource container;
using, by the one or more processors, the identified set of IT resources as the first set of IT resources used to generate the IT resource group;
generating, by the one or more processors, an IT infrastructure specification based on the generated IT resource group; and
updating, by the one or more processors, the IT infrastructure based on the IT infrastructure specification.

17. The non-transitory computer-readable medium of claim 13, the computer-implemented method further comprising:
identifying, by the one or more processors, a first IT resource that was not in the first set of IT resources;
receiving, by the one or more processors, an IT infrastructure specification associated with the first IT resource;
identifying, by the one or more processors, a second IT resource in the first dependency graph that is an ancestor of the first IT resource;
adding, by the one or more processors, the second IT resource to the IT infrastructure specification to generate an updated IT infrastructure specification; and
applying, by the one or more processors, the updated IT infrastructure specification to the second IT resource.

18. The non-transitory computer-readable medium of claim 13, the computer-implemented method further comprising:
receiving, by the one or more processors, second INCLUDES and EXCLUDES configuration data for generating a first IT resource list;
adding, by the one or more processors, a first IT resource of the IT resource group to the first IT resource list upon determining that the first IT resource is identified in the second INCLUDES configuration data;
adding, by the one or more processors, a second IT resource of the IT resource group to the first IT resource list upon determining that the second IT resource is a descendant of the first IT resource;
generating, by the one or more processors, a second IT resource list by excluding a third IT resource from the first IT resource list upon determining that the third IT resource is identified in the second EXCLUDES configuration data;
identifying, by the one or more processors, an IP address for each IT resource in the second IT resource list;
generating, by the one or more processors, an IT resource rule based on the identified IP addresses; and
updating, by the one or more processors, the IT infrastructure based on the IT resource rule.

19. The non-transitory computer-readable medium of claim 13, the computer-implemented method further comprising:
identifying, by the one or more processors, an IT infrastructure policy for the IT infrastructure;
identifying, by the one or more processors, second INCLUDES and EXCLUDES configuration data corresponding to an IT resource selection criteria for the IT infrastructure policy;
generating, by the one or more processors, an IT resource list using the IT resource group and the second INCLUDES and EXCLUDES configuration data;
determining, by the one or more processors, an IT policy compliance of the IT resources of the IT resource list based on the IT infrastructure policy;
generating, by the one or more processors, IT policy compliance results; and
updating, by the one or more processors, the IT infrastructure based on the IT policy compliance results.

20. The non-transitory computer-readable medium of claim 13, the computer-implemented method further comprising:
receiving, by the one or more processors, an IT infrastructure specification;
generating, by the one or more processors, second INCLUDES configuration data based on IT resources included in the IT infrastructure specification;
generating, by the one or more processors, a second IT resource group and updated EXCLUDES configuration data using the first IT resource group and based on the second INCLUDES configuration data;
identifying, by the one or more processors, differences between the first IT resource group and the second IT resource group; and
updating, by the one or more processors, the IT infrastructure based on the identified differences between the first IT resource group and the second IT resource group.
